(19) United States
(12) Patent Application Publication
(10) Pub. No.: US 2002/0027364 A1
(43) Pub. Date: Mar. 7, 2002

(54) Child-key guard unit

(76) Inventor: Earl M. Trammel JR., Chesterfield, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/851,351

(22) Filed: May 9, 2001

Related U.S. Application Data
(63) Continuation-in-part of application No. 09/504,763, filed on Feb. 15, 2000.
Application No. 09/504,763 is a continuation-in-part of application No. 09/289,869, filed on Apr. 12, 1999, now Pat. No. 6,131,965.
Application No. 09/289,869 is a continuation of application No. 08/864,590, filed on May 28, 1997, now abandoned.
Application No. 08/864,590 is a continuation-in-part of application No. 08/786,746, filed on Jan. 24, 1997, now Pat. No. 5,927,775.
Application No. 08/786,746 is a continuation-in-part of application No. 08/534,642, filed on Sep. 27, 1995, now Pat. No. 5,676,409.

(51) Int. Cl. E05C 19/00; E05C 21/00

(52) U.S. Cl. 292/1

(57) ABSTRACT

A child-safety door locking system for an automobile door has a shield movable relative to the interior door panel of the door between a retracted inoperative position corresponding to a normal lock mode and an extended operative position corresponding to a guard lock mode. In the inoperative position the shield is withdrawn from the manual lock actuator of the door whereby in the locked position the manual lock actuator may be manually grasped and moved to its unlocked position. In the operative position the shield occupies a position relative to the door panel and manual lock actuator so that the manual lock actuator is shielded in its locked position to block access to the manual lock actuator for manual movement to its unlocked position. The lock actuator is otherwise moveable to its unlocked position when the shield is in its operative position.

### CROSS REFERENCE TO RELATED APPLICATION

This application is a continuation-in-part of my co-pending U.S. patent application Ser. No. 09/504,763, filed Feb. 15, 2000, which is a continuation-in-part of U.S. Pat. No. 6,131,965, issued on Oct. 17, 2000, which is a continuation of U.S. Patent application Ser. No. 08/864,590, filed May 28, 1997, which is a continuation-in-part of U.S. Pat. No. 5,927,775, issued Jul. 27, 1999, which is a continuation-in-part of U.S. Pat. No. 5,676,409, issued Oct. 14, 1997.

### BACKGROUND OF THE INVENTION

This invention relates generally to door locking systems, and more particularly to standard equipment child-safety door locking systems for automobile doors.

There are presently systems which prevent the rear doors of automobiles from being unlocked and opened by children while the automobile is in motion. At present, all major car makers are incorporating as standard equipment a child-safety locking system of European origin that consists of adding a separate mechanical unit to the rear doors in addition to the regular locking unit. This child safety locking unit has a small lever that is positioned on the face of the door panel which requires that the door be opened to access the lever. The child safety locking unit requires manual setting for (1) normal locking and (2) child-safety locking. Normal locking permits the door to be locked, unlocked and opened by manipulation of the regular locking unit and door latch from inside the vehicle. However, when child safety locking is activated the door becomes totally inoperable from the inside whether the regular locking unit is locked or unlocked. The door may then be opened only from the outside, and then only when the regular locking unit is unlocked.

This means that when child safety locking is activated, the driver always has the inconvenience of having to exit the car in order to let the children in the rear out. There is this same aggravation when adults are in the rear and the driver forgets to position the lever to return the door to normal locking. Also, the driver has no visual reference as to whether the rear doors are in a child safety or normal locking mode. The driver must make sure the locking unit of the rear door is unlocked, and either: (1) strain to reach back and check the rear door handles; or (2) exit the car and open the rear door from the outside. Moreover in certain circumstances, such as in an accident where the car rolls upside down, the driver may not be able to unlock or to open the rear door from outside the automobile. The child safety power door locking system of the present invention completely eliminates the above problems and inconveniences as well as providing for other substantial advantages over the present system.

I patented Child-Guard® rear door lock actuator shields in the 1950's (e.g., U.S. Pat. Nos. 2,955,858, 2,694,917, 2,708,845, 2,735,289 and 2,939,307). Power locks were not available at this time. My lock actuator shields were designed and made by my company, E-M-T Enterprises, for General Motors, Ford, Chrysler and American Motors cars, and were sold in volume from 1956 until 1987. Production ceased only in 1991 at which time all automobile manufacturers had incorporated the European child-safety locking system as standard equipment. My Child-Guard® lock actuator shields were confined accessory products, sold only to the major car companies.

Generally speaking, my prior actuator shields have an opening for receiving the manual look actuator in closely spaced relation with the shield. There is too little space between the shield and the lock actuator in the opening to grasp the lock actuator, or even to insert a thin instrument such as a key to pry the lock actuator back to an unlocked position. However, these shields have a slot (i.e., a second opening) in them which is too small for a child's fingers to reach the lock actuator, but which would permit insertion of the car key through the shield to unlock the door. Power door locking was not available on automobiles until the early 1970's. However, sales of my accessory lock shields continued to be strong until the late 1980's when nearly all automobiles began to incorporate the European child safety locking system described previously.

My original child safety manual lock actuator shields were an accessory product that where installed around the standard equipment manual lock actuator and used a car key for unlocking.

### SUMMARY OF THE INVENTION

The invention presented herein and in the previously filed co-pending application Ser. No. 09/504,763 and U.S. Pat. Nos. 5,676,409 and 5,927,775, which are incorporated herein by reference, introduces to the automobile maker a new standard equipment child-safety locking system that operates in direct combination with power door locking systems on all makes of new cars. My new child safety door key locking system is standard equipment. It does not use a slotted shield and cannot be manipulated with a car key. Rather, the sole means for unlocking the door when the locking system is operating in a guard lock mode is by either a key adapted for use with a key lock installed as part of the locking system, or by the power door locking unit if the automobile has a power locking system. My new locking system incorporates the integral action of: (1) normal locking; (2) hand guard shielding; and (3) key locking or power door locking, not previously found in child-safety door locking systems.

This new child-safety locking system, which operates in both a guard lock mode and a normal lock or conventional mode in which the door locks can be manually opened at any time, provides for definite improvements over the European child safety locking system that is now being used as standard equipment by all the major car manufacturers. Specifically, this new system will be mechanically simpler, cost less and also be more dependable and convenient to operate. There is no separate mechanism which must be added to the standard door locking mechanism or the power locking mechanism, thereby eliminating the need and cost for an additional unit and reducing the possibility of malfunction. Additionally, it will provide the driver with quick, positive and convenient control over child-safety locking and unlocking that was not previously available.

Common to the embodiments of the present invention is an operative connection of an actuator shield to a key lock whereby rotation of the key lock effects movement of the shield between operative and inoperative positions corresponding respectively to guard lock and normal lock modes of operation of the locking system. However, while in these embodiments the key is used to change lock modes of the locking system, the power locking system still allows the driver to quickly open the rear doors via the power door button. However, where a power locking system is unavailable or inoperable, the key lock and easy to use key (which can be kept on a key ring) provide the driver with a quick, alternative means for repositioning the shield to the normal lock mode in a matter of seconds.

Among the several objects of this invention may be noted the provision of an improved child-safety door locking system for an automobile which prevents a child from unlocking the door from the inside; the provision of such a door locking system which permits the locked door to be unlocked without exiting the automobile to do so; the provision of such a door locking system which can be activated remotely from the door (e.g., at the front doors); the provision of such a door locking system which can be deactivated for normal locking and unlocking operation of the door; the provision of such a door locking system which visually indicates within the interior of the automobile whether the locking system is in a guard lock mode or normal lock mode; the provision of such a door locking system which is inexpensive; the provision of such a door locking system which is readily made as standard equipment on an automobile; and the provision of such a door locking system which is easy to manufacture and to use.

In general, a child-safety door locking system of the present invention for use on an automobile door comprises a latch, a handle operatively connected to the latch for latching and unlatching the door, and a locking mechanism operable to lock and unlock the latch. The door handle is incapable of operating to unlatch the door when the locking mechanism locks the latch. The child-safety door locking system is capable of being selectively switched between a normal lock mode in which the door can be manually locked and unlocked, and a guard lock mode in which the door cannot be manually unlocked. An interior door panel having an inner surface and an outer surface is also included, with the outer surface of the door panel having a pocket formed therein. A manual lock actuator is operatively connected to the locking mechanism of the door and is disposed at least partially outside the outer surface of the door panel generally within the pocket formed therein. The manual lock actuator is manually movable in the normal lock mode relative to the interior door panel from a location outside the outer surface of the door panel generally within the pocket between a locked position in which the latch on the door is locked and an unlocked position in which the latch on the door is unlocked. A shield is movable relative to the interior door panel and the manual lock actuator between a retracted inoperative position corresponding to the normal lock mode and an extended operative position corresponding to the guard lock mode. In the inoperative position the shield is withdrawn from the manual lock actuator whereby in the locked position the manual lock actuator may be manually grasped and moved to its unlocked position. In the operative position the shield occupies a position relative to the door panel and manual lock actuator on the outside surface of the door panel generally within the pocket formed therein so that the manual lock actuator is shielded in its locked position to block access to the manual lock actuator for manual movement to its unlocked position. The lock actuator is otherwise moveable to its unlocked position when the shield is in its operative position corresponding to the guard lock mode of the locking system. A key lock is adapted to receive a key therein to permit movement of the key lock between a first position corresponding to the normal lock mode and a second position corresponding to the guard lock mode. The key lock is operatively connected to the shield in a rack and pinion connection such that turning of the key in the lock effects linear movement of the shield relative to the interior door panel and the manual lock actuator between the normal lock mode and the guard lock mode of the locking system.

Other objects and features will be in part apparent and in part pointed out hereinafter.

### BRIEF DESCRIPTION OF THE DRAWINGS

FIG. 1 is a perspective view of an automobile door including a child-safety locking system of a first embodiment including a lock button type manual lock actuator, a door latch, and a power lock actuator;

FIGS. 2A and 2B are fragmentary vertical sections of the door showing the lock button in a normal lock mode in its unlocked and locked positions, respectively;

FIGS. 3A and 3B are fragmentary vertical sections of the door showing the lock button in a guard lock mode in its unlocked and locked positions, respectively;

FIGS. 4A and 4B are fragmentary vertical sections of the door, but showing a child-safety locking system of a second embodiment which always operates in the guard lock mode;

FIG. 5 is a fragmentary elevation of a door showing a lever type manual lock actuator incorporating a child-safety locking system of a third embodiment of the present invention;

FIG. 6 is a fragmentary section taken in the plane including line 6-6 of FIG. 5 but showing the lock actuator in a guard lock mode in its locked position;

FIG. 7 is similar to FIG. 6 but showing a cap screw and lever exploded from a lock rod and the manual lock actuator;

FIG. 8 is an elevation of another lever type manual lock actuator of a child-safety locking system of a fourth embodiment with parts of its shield broken away to show internal construction;

FIG. 9 is a fragmentary elevation of a door showing a slide type manual lock actuator, and a child-safety locking system of a fifth embodiment;

FIG. 10 is a section taken in the plane including line 10-10 of FIG. 9;

FIG. 11 is section similar to FIG. 10 but showing a child-safety system of a sixth embodiment in a guard lock mode;

FIG. 12 is the section of FIG. 11 but showing the child-safety locking system in a normal lock mode;

FIG. 13 is an elevation of a key for use in changing the child-safety system of the sixth embodiment between the guard lock and normal lock modes;

FIG. 14 is a schematic illustrating a power locking system used in the present invention;

FIG. 15 is a fragmentary elevation of a door showing a child-safety locking system incorporating another lever type manual lock actuator of a seventh embodiment of the present invention showing the locking system in a normal lock mode;

FIG. 16 is the fragmentary elevation of FIG. 15 but showing the child-safety locking system in a guard lock mode;

FIG. 17 is a fragmentary section of the lever type manual lock actuator of FIG. 15;

FIG. 18 is a fragmentary section of the lever type manual lock actuator of the seventh embodiment taken in the plane including line 18-18 of FIG. 17;

FIG. 19 is a top view of the lever type manual lock actuator of FIG. 15 with a cap removed to reveal internal structure;

FIG. 20 is a bottom view of the cap of the lever type manual lock actuator of FIG. 15;

FIG. 21 is a fragmentary end view of the door of FIG. 15 but showing the child-safety locking system in a locked position in the guard lock mode.

FIG. 22 is an elevation of a key for use in changing the child-safety system of the seventh embodiment between the guard lock and normal lock modes; and

FIG. 23 is a fragmentary vertical section of a child-safety locking system of an eighth embodiment including a lock button type manual lock actuator and showing the locking system in a normal lock mode and the lock button in an unlocked position;

FIG. 24 is a fragmentary elevation of the door locking system of FIG. 23 showing the lock button in a locked position and with parts broken away to show internal construction;

FIG. 25 is the fragmentary vertical section of FIG. 23 showing the door locking system in a guard lock mode and the lock button in a locked position;

FIG. 26 is the fragmentary elevation of FIG. 24 showing the door locking system in a guard lock mode and the lock button in an unlocked position;

FIG. 27 is a fragmentary horizontal section of the door locking system of FIG. 23.;

FIG. 28 is a cross-section of a key lock of the door locking system taken in the plane of line 28-28 of FIG. 27;

FIG. 29 is a fragmentary outer end view of the door locking system of FIG. 23;

FIG. 30 is a fragmentary vertical section of a child-safety locking system of a ninth embodiment including a lock button type manual lock actuator and showing the locking system in a normal lock mode and the lock button in an unlocked position;

FIG. 31 is a fragmentary front elevation of the locking system of FIG. 30 with the lock button in a locked position;

FIG. 32 is a fragmentary rear elevation of the locking system of FIG. 30;

FIG. 33 is a fragmentary rear elevation thereof showing the locking system in a guard lock mode and the lock button in a locked position;

FIG. 34 is a fragmentary side elevation thereof showing the locking system in a normal lock mode and the lock button in a locked position, with portions of the locking system shown in section to reveal internal structure;

FIG. 35 is a front elevation of a child-safety locking system of a tenth embodiment including a lever type manual lock actuator and showing the locking system in a guard lock mode and the lock button shown in phantom in a locked position;

FIG. 36 is similar to FIG. 35 but showing the locking system in a normal lock mode and the lock button in an unlocked position;

FIG. 37 is a section view taken in the plane of line 37-37 of FIG. 35;

FIG. 38 is a section view taken in the plane of line 38-38 of FIG. 36;

FIG. 39 is a front elevation of a child-safety locking system of an eleventh embodiment including a lever type manual lock actuator and showing the locking system in a normal lock mode and the lock button in a locked position, with the guard lock mode of the locking system and the unlocked position of the lock button indicated in phantom;

FIG. 40 is a fragmentary section view taken in the plane of line 40-40 of FIG. 39;

FIG. 41 is a fragmentary partial section of a child-safety locking system of a twelfth embodiment including a lock button type manual lock actuator and showing the locking system in a normal lock mode and the lock button in an unlocked position;

FIG. 42 is a fragmentary front elevation of the locking system of FIG. 41 with the lock button in a locked position;

FIG. 43 is a fragmentary rear elevation of the locking system of FIG. 41 with the locking system in a normal lock mode and the lock button in an unlocked position;

FIG. 44 is a fragmentary rear elevation thereof showing the locking system in a guard lock mode and the lock button in a locked position; and

FIG. 45 is a fragmentary side elevation thereof showing the locking system in a normal lock mode and the lock button in a locked position, with portions of the locking system shown in section to reveal internal structure.

Corresponding parts are indicated by corresponding reference numerals throughout the several views of the drawings.

### DETAILED DESCRIPTION OF THE PREFERRED EMBODIMENTS

Now referring to the drawings, specifically FIG. 1, the reference numeral 101 refers generally to a rear or passenger side door of an automobile. A latch, generally indicated at 103 is mounted on the inside of a door frame 105. When the door 101 is closed, the latch 103 engages an automobile frame (not shown) on which the door is mounted to secure the door closed. To open the door 101, the latch 103 is unlatched from the automobile frame. An interior door panel 107 covers the door frame 105. A handle 109 mounted on the interior door panel 107 is connected to the latch 103 in a conventional manner such that it operates to latch and unlatch the door 101. A locking mechanism, shown generally at 111, is connected to the latch 103 such that it is capable of locking and unlocking the latch. When the locking mechanism 111 is in a locked position, it overrides the connection between the handle 109 and the latch 103 so as to render the handle incapable of unlatching the door 101. The construction of the locking mechanism 111 and latch 103 to prevent the handle 109 from being used to unlatch the door 101 when it is locked is well known to those of ordinary skill in the art and will not be described herein. Attached to the locking mechanism 111 is a manual lock actuator 113 extending through the interior door panel 107 to allow manual actuation of the locking mechanism 111 to lock and unlock the latch 103.

An important feature of the locking system, in combination with the manual lock actuator 113 and door panel 107, is a power locking system (generally indicated at 119) of the automobile shown schematically in FIG. 14. The power locking system 119 includes a power lock actuator, shown generally at 112, mounted on each of the four doors (designated 101, 101A, 101B, and 101C) of the automobile. The power lock actuator 112 is used to automatically move the locking mechanism 111 to lock and unlock the latch 103. The power lock actuators 112 are connected by electrical wires to a control panel 116 located near the driver's seat. By toggling a switch (not shown) on the control panel 116, the driver is capable of locking and unlocking all of the doors 101-101C. As incorporated in the various embodiments of the locking system described hereinafter, the power locking system 119 is the only means of moving the locking mechanism 111 to unlock the latch 103 on the door 101 when the manual lock actuator 113 is in the locked position in the guard lock mode.

There are seven embodiments of the invention disclosed in the figures contained herein. For ease of cross-referencing between embodiments, the first digit of each reference number will correspond to the embodiment shown. The last two digits of each reference number will correspond to the specific item, such that corresponding items appearing in different embodiments are consistently referenced with the only difference in reference numbers being the first digit.

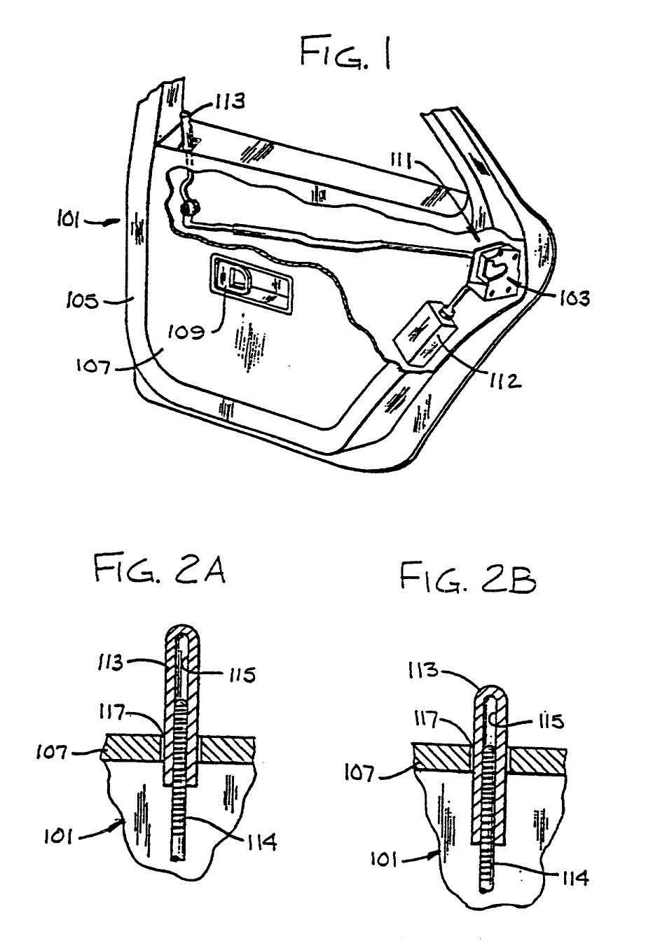

As shown in FIGS. 1-3B, the child-safety locking system of the first embodiment includes a lock button type manual lock actuator 113 screwed onto the end of a lock rod 114. The lock button 113 is generally cylindrical in shape and has an internally threaded hole 115 extending up from its bottom for threading onto a threaded end of the lock rod 114 in an opening 117 in the interior door panel 107. The other end of the lock rod 114 is connected to the locking mechanism 111 such that when the lock button 113 is pushed down to its locked position (FIG. 2B) the locking mechanism locks the latch 103, and when the lock button 113 is pulled up to its unlocked position (FIG. 2A) the locking mechanism unlocks the latch.

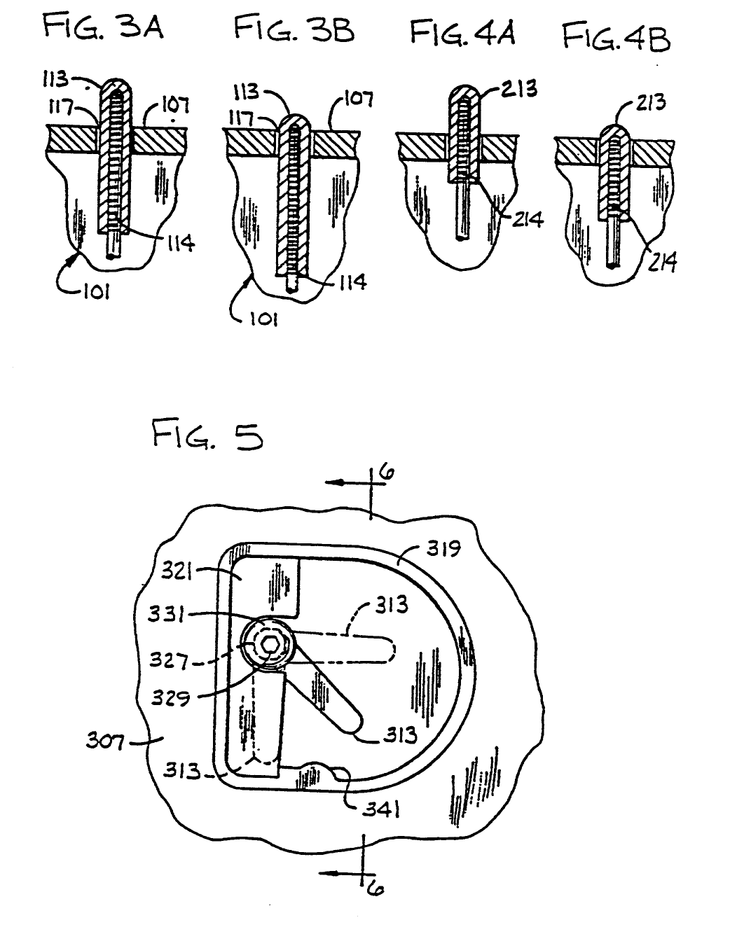

The child-safety locking system of the first embodiment is capable of being selectively switched between a normal lock mode (FIGS. 2A and 2B) and a guard lock mode (FIGS. 3A and 3B). The lock button 113 of the first embodiment is made sufficiently long so that enough threads in the lock button are engaged with the threads of the lock rod 114 when the lock button is screwed only about half way down on the lock to secure the lock button on the lock rod. As shown in FIG. 2B, the lock button 113 projects out of the opening 117 in the interior door panel 107 in its locked position a distance such that the lock button may be manually grasped and moved back to its unlocked position (FIG. 2A).

To switch to its guard lock mode of operation, the lock button 113 is fully screwed onto the lock rod 114 as shown in FIGS. 3A and 3B. When the lock button 113 is in the unlocked position (FIG. 3A), the lock button extends up from the top of the interior door panel 107 as before. However, when pushed down to its locked position (FIG. 3B), the lock button 113 is almost fully recessed through the opening 117 in the top of the interior door panel 107. The lock button 113 and opening 117 in the door panel 107 are sized so that there is very little space between the lock button and the periphery of the opening. Thus in the guard lock mode, the lock button 113 cannot be accessed manually for moving the lock button back to its unlocked position. It is envisioned that structure (not shown) could be provided for releasably fixing the lock button 113 on the lock rod 114 in the normal lock mode and the guard lock mode.

It will be noted that the interior door panel 107 surrounding the opening 117 in which the lock button 113 is positioned is solid. Thus, there are no other openings which provide access to the lock button 113 for manually moving it from its locked position in the guard lock mode to an unlocked position. In that regard, the present invention differs from my prior inventions, described above, in which a slot provided an opening in addition to the opening into which the manual lock actuator recessed for access to the lock button to manually move the lock button back to an unlocked position with the end of a thin, rigid object such as a key. In the present invention there is no opening in addition to the opening 117 so it would not be possible to use a key or similar object to access the lock button 113 in the locked position to manually return it to the unlocked position.

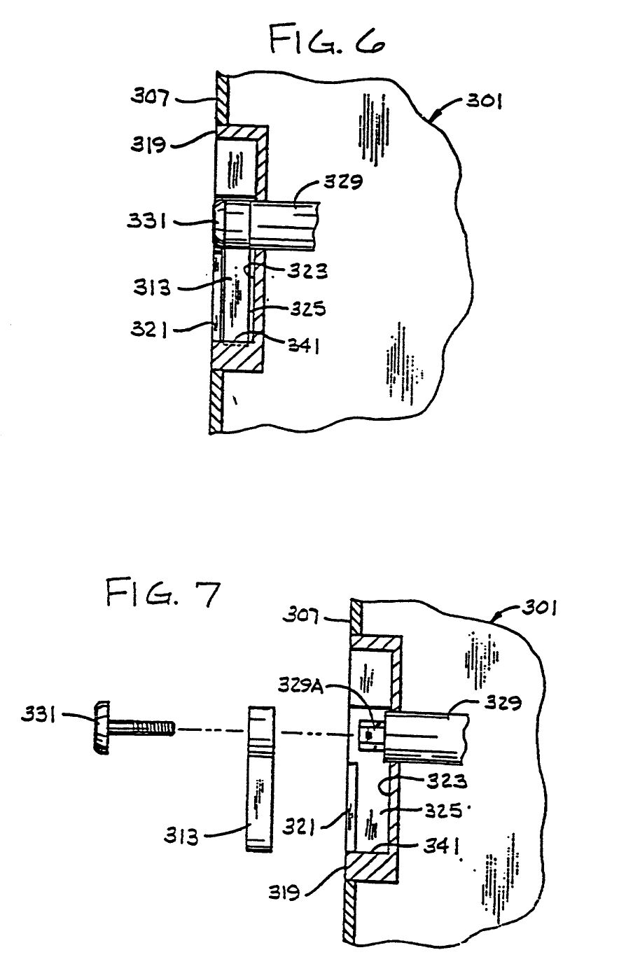

A second embodiment of the child-safety locking system shown in FIGS. 4A and 4B comprises a lock button 213 which is substantially shorter than the lock button 113 of the first embodiment so that the lock button 213 operates solely in the guard lock mode. The lock button 213 of the second embodiment can be secured on the lock rod 214 only when the lock button is screwed all the way down onto the lock rod. It will be noted that the lock rod 114 of the first embodiment preferably has more threads than the lock rod 214 of the second embodiment.

Referring now to FIGS. 5-7, a child-safety locking system of a third embodiment is shown to comprise a lock lever type manual lock actuator 313 mounted on the side of the interior door panel 307 in a locking frame 319 (constituting part of the door panel in this embodiment) which is recessed into the door panel. The locking frame 319 includes a shield 321 which defines a pocket 323 (FIGS. 6 and 7) in which the lock lever 313 may be received. The pocket 323 has an opening 325 through which the lock lever 313 may enter the pocket. The opening 325 and lock lever 313 are sized so that when the lock lever is in the pocket 323, there is little space between them. Thus, a finger cannot be inserted into the pocket 323 to move the lock lever 313 back out of the pocket once it enters. The lock lever 313 has an octagonal opening 327 at its inner end which is sized for receiving an octagonally shaped end 329A of a lock stud 329 such that the lock lever and lock stud are connected for conjoint rotation about the longitudinal axis of the lock stud. A cap screw 331 fastens the lock lever 313 on the lock stud 329, which extends into the interior of the door for connection, by way of a lock rod to the locking mechanism (not shown). Rotation of the lock lever 313 operates the locking mechanism to lock and unlock the latch (not shown).

The child-safety locking system of the third embodiment is also capable of switching between a normal lock mode and a guard lock mode. The cooperating octagonal opening 327 in the lock lever 313 and octagonal end 329A of the lock stud 329 permit the lock lever to be fixed in several angular positions on the lock stud. In the normal lock mode, the lock lever 313 is fastened to the lock rod 329A by the cap screw 331 such that the lock lever is secured in a first angular orientation relative to the lock stud 329. In the first angular orientation, the lock lever 313 remains outside of the pocket 323 in both its locked and unlocked position. The unlocked position of the lock lever 313 mounted on the lock stud 329 is shown in phantom lines in FIG. 5. The locked position of the lock lever 313 in the first orientation is illustrated in solid lines. Thus, it may be seen that the lock lever 313 is readily manually accessible in its locked position in the normal lock mode to be moved back to its unlocked position.

To operate in the guard lock mode, the cap screw 331 and lock lever 313 are removed from the lock stud 329 in the unlocked position of the lock lever (FIG. 7). The lock lever 313 is turned in a clockwise direction toward the shield 321 to a second angular orientation relative to the lock stud 329, and placed back onto the lock stud. The cap screw 331 is reapplied to the lock stud 329 to secure the lock lever 313 in the second angular orientation. In the unlocked position of the lock lever 313 in the guard lock mode, the lever has the position shown in solid lines in FIG. 5., where it is accessible to be pushed in a clockwise direction to its locked position (shown in hidden lines in FIG. 5) in the pocket 323 defined by the shield 321. As shown in FIG. 6, the close spacing between the lock lever 313 and the shield 321 prevents a finger or other object from being inserted through the opening 325 past the lock lever to move it back to the unlocked position. Thus, the door 101 cannot be manually unlocked in the guard lock mode.

A hump 341 in the lower part of the locking frame 319, located just in front of the opening 325, blocks any attempt to insert a finger underneath the lock lever 313 in its locked position to move it manually back to its unlocked position. It will be noted that the shield 321 and locking frame 319 are solid in the area surrounding the opening 325 so that there is no other opening besides the opening giving access to the lock lever 313. Thus, referring to FIG. 1 and FIG. 14, the only way to unlock the door 101 in the guard lock mode of the locking system is to use the power locking system 119 controlled from the control panel 116 on the driver's side front door.

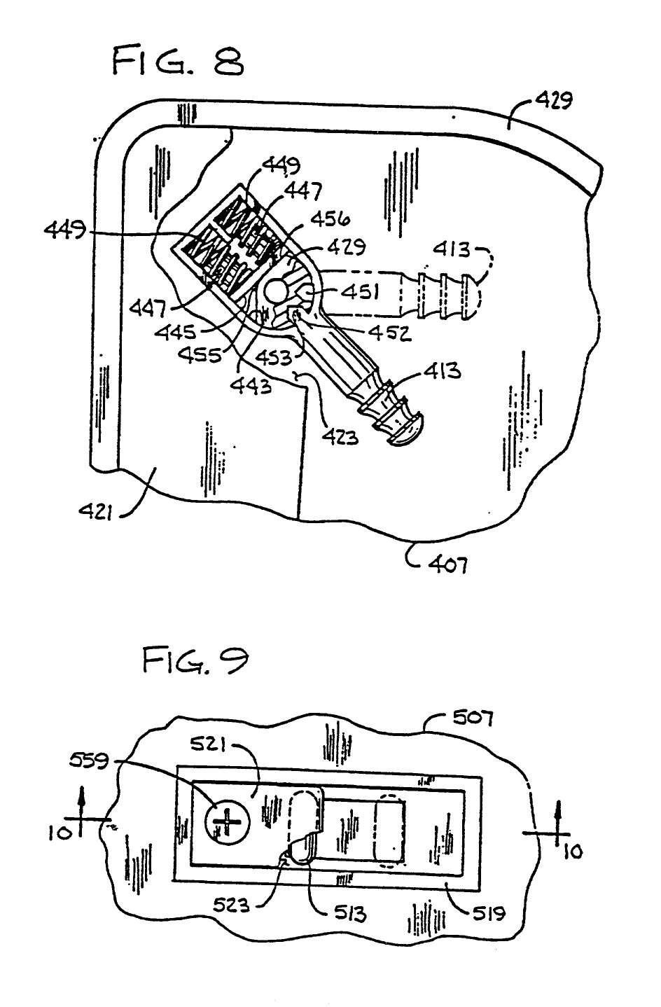

A fourth embodiment of the child-safety locking system (FIG. 8) has a lock lever 413 similar to that of the third embodiment, but has adjustable mounting structure which is more convenient than the cap screw 331 of the third embodiment. The fourth embodiment permits changing the position of the lock lever 413 from the first angular orientation (corresponding to the normal lock mode) to the second angular orientation (corresponding to the guard lock mode) without removing the lock lever from the lock stud 429. The lock lever 413 is shown in its unlocked positions in FIG. 8. The solid line representation illustrates the lock lever 413 in the guard lock mode, and the phantom line representation illustrates it in the normal lock mode.

The lock lever 413 may be selectively clamped onto the lock stud 429 in either the guard lock or normal lock mode. In that regard, one end of the lock lever is formed with an opening 443 sized to receive the end of the lock stud 429. One wall of the opening 443 is defined by a clamp 445 which is slidably mounted on the lock lever 413 for movement generally longitudinally of the lock lever. The side of the clamp 445 opposite the lock stud 429 has a pair of nubs 447 which each receive an end of a respective coil compression spring 449 bearing against the clamp and against a reaction surface of the lock lever generally opposite the clamp. The springs 449 bias the clamp 445 into gripping engagement with the lock stud 429 and are selected to be sufficiently strong to prevent a small child from being able to change the orientation of the lock lever 413 relative to the lock stud. As clamped onto the lock stud 429 in either orientation, the lock lever 413 and lock stud are rotatable conjointly about the axis of the lock stud.

The lock stud 429 has a first aperture 451 and a second aperture 452 sized to receive a locator pin 453 on the lock lever 413 to positively locate the lock lever in the first and second angular orientations relative to the lock stud corresponding to the normal lock and guard lock modes, respectively. The lock stud 429 has two flat surfaces (designated 455 and 456, respectively), a first of which (surface 455) is engaged by the clamp 445 in the normal lock mode of the system and a second of which (surface 456) is engaged by the clamp in the guard lock mode of the system. The flat surfaces 455, 456 permit a secure, positive location of the lock lever 413 relative to the lock stud 429.

The lock lever 413 is adjusted to change the locking system from a normal lock mode to a guard lock mode by pulling outward on the lock lever at its end opposite the lock stud 429 to unseat the locator pin 453 from the first aperture 451. The lock lever 413 is then rotated clockwise relative to the lock stud 429 about the axis of the lock stud until the locator pin 453 is in registration with the second aperture 451. The lock lever 413 is released and the springs 449 and clamp 445 operate to seat the locator pin 453 in the second aperture 452. The lock lever 413 is now joined with the lock stud 429 in the guard lock mode of the locking system. As before in the guard lock mode, the lock lever 413 may be returned to its unlocked position only by operation of the power locking system 119. It is apparent that the foregoing steps may be reversed to change the locking system back to the normal lock mode.

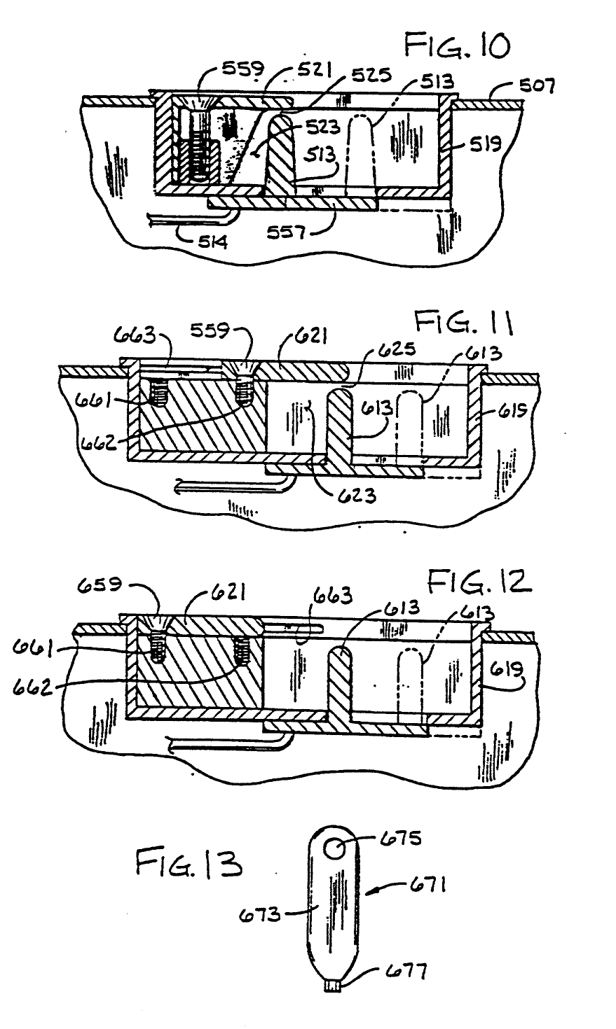

A child-safety locking system of a fifth embodiment is shown in FIGS. 9-10 to include a slide type manual lock actuator 513 mounted to the side of the interior door panel 507 by a locking frame 519 recessed into the door panel. The locking frame 519 constitutes part of the interior door panel 507 in this embodiment. A slide 513 extending outward from the locking frame 519 is connected to a slide plate 557 behind the locking frame. The slide plate 557 is connected to the locking mechanism 111 by a lock rod 514 such that the slide 513 can be moved translationally along the locking frame 519 to lock and unlock the latch 103. A shield 521 connected to the locking frame 519 by a screw 559 defines with the locking frame a pocket 523 for receiving the slide 513 in its locked position. The pocket 523 has an opening 525 through which the slide 513 passes into the pocket. The opening 525, pocket 523 and slide 513 are sized such that it is not possible to grasp the slide with one's fingers in the locked position. Moreover, the slide 513 cannot be manipulated with a key or similar thin, rigid object in its locked position to move it back to the unlocked position. The slide 513 can be moved back to its unlocked position by operation of the power locking system 119.

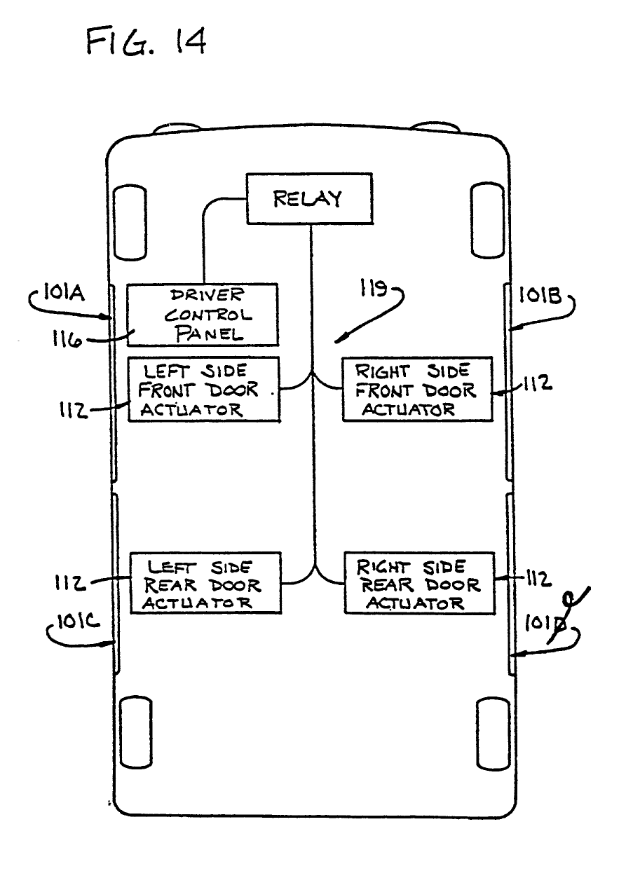

It is possible to convert the locking system of the fifth embodiment to operate in a normal lock mode by removing the shield 521. To do this, the screw 559 is taken out and the shield 521 is removed. However, a sixth embodiment of the present invention shown in FIGS. 11 and 12 is more conveniently switched between guard lock and normal lock modes. The locking system of the sixth embodiment is substantially the same as that of the fifth embodiment except for the construction of the shield 621. The shield 621 of the sixth embodiment is slidable longitudinally of the locking frame 619 between the guard lock mode (FIG. 11) and the normal lock mode (FIG. 12). The shield 621 has tabs (not shown) on each edge which ride in grooves 663 (only one is shown) in the locking frame 619. The shield 621 is secured in either position by a screw 659 received through a single opening in the shield and either of two openings (designated 661 and 662, respectively) in the locking frame 619 corresponding to the guard lock and normal lock modes, respectively. Thus, it may be seen that there are no unused parts to be stored in either the guard lock or normal lock mode because the shield 621 remains attached to the door. In the guard lock mode, the shield 621 cooperates with the locking frame 619 to define a pocket 623 and opening 625 as in the fifth embodiment.

Switching the locking system of the sixth embodiment from one lock mode to the other is facilitated by the provision of a hex head key, indicated generally at 671 in FIG. 13, which can be used as a screwdriver to loosen and tighten the screw 659. The key 671 has a wide body 673 which can be easily gripped for turning the key. A hole 675 in the end of the body 673 opposite a head 677 is sized to receive a key chain (not shown). Thus, the key 671 can be conveniently carried around to be used to change the lock mode of the locking system. It is to be understood that the key 671 could also be used with any of the locking systems employing screws to hold the locking system in one lock mode or the other.

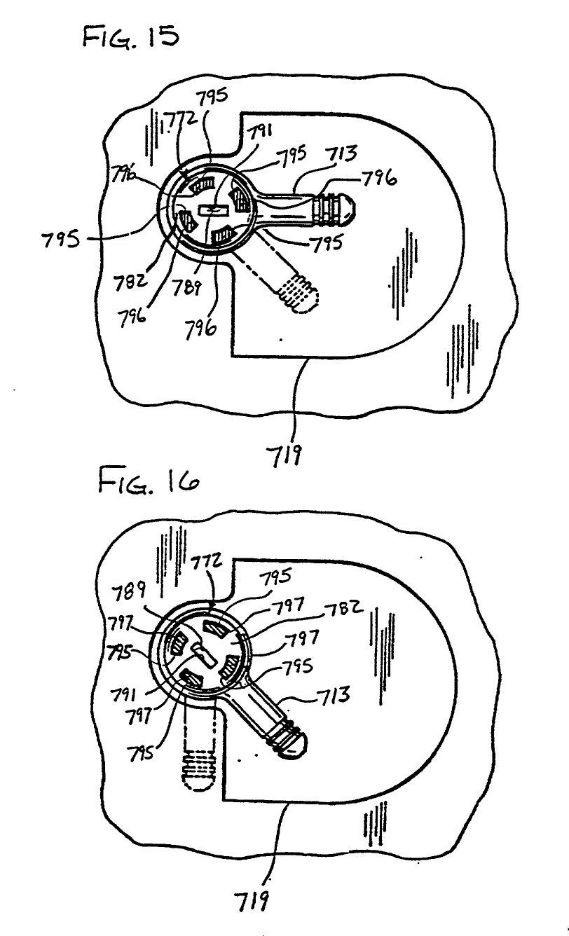

A seventh embodiment of the child-safety locking system (FIGS. 15-22) has a lock lever 713 similar to that of the third and fourth embodiments. The child-safety locking system of this embodiment incorporates my novel “Child-Key-Guard Unit”. In this embodiment a key lock, generally indicated at 772, and lock housing 774 define the adjustable mounting structure for adjusting the mode of the locking system between the normal lock mode and the guard lock mode without removing the lock lever from the lock stud 729. The lock lever 713 has a bore 773 extending therethrough sized for rotatably mounting the lock lever on the lock housing 774. This embodiment also provides for visually identifying which mode the locking system is in from inside the automobile.

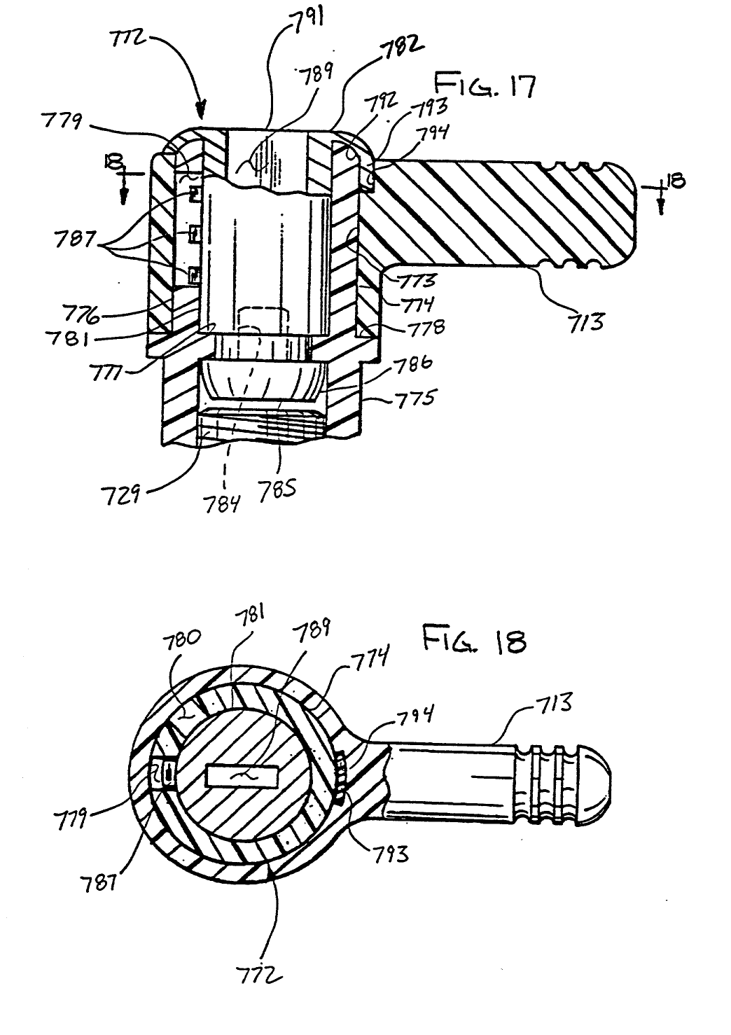

The lock housing 774 (FIG. 17) is generally tubular and has an internally threaded connecting end 775 adapted for engagement with external threads of the lock stud 729 to operatively connect the lock housing with the locking mechanism (not shown) via the lock stud and lock rod (not shown, but substantially similar to the lock rod 114 of FIG. 1). Although the lock housing 774 is illustrated as a separate piece connected to the lock stud 729, the two may be formed as one piece, or the lock housing, lock stud and lock rod may all be formed as one piece. It is to be understood, for purposes of the claims, that the lock stud 729 is part of the lock rod. The lock housing 774 has an outer end 776 for housing the key lock 772, and an internal annular shoulder 777 defining a seat for the key lock within the housing. The internal annular shoulder 777 is spaced apart from the lock stud 729 when the housing is connected to the lock stud. An external annular shoulder 778 of the lock housing 774 defines a seat for the lock lever 713 when the lever is mounted on the housing. In this manner, the lock lever 713 is free of any connection with the lock housing 774 and is thus capable of rotating movement with respect to the lock rod. The housing 774 has a pair of internal channels 779, 780, each extending longitudinally between the internal annular shoulder 777 and outer end 776 of the housing. The channels 779, 780 correspond, respectively, to the normal lock mode and guard lock mode of the locking system. In the preferred embodiment, these channels 779, 780 are spaced apart approximately 45°. However, this spacing may vary without departing from the scope of the invention.

With reference to FIGS. 17 and 18, the key lock 772 comprises a lock cylinder 781 sized for seating within the lock housing 774 in closely spaced relationship with the housing, and a cap 782 integrally formed with the cylinder adapted for connection with the lock lever 713. The lock cylinder 781 corresponds closely in construction to a conventional wafer lock, such as the type of lock used in file cabinets and the like. However, pin locks and other suitable locks (not shown) may be used without departing from the scope of this invention. The lock cylinder 781 seats against the internal annular shoulder 777 of the housing and has a longitudinally extending threaded bore 784 therein. A suitable fastener, such as a screw 785 having a head 786 sized larger than the inner diameter of the internal annular shoulder 777, threadably engages the lock cylinder 781 with the shoulder positioned between the cylinder and the screw head to hold the cylinder against movement outward from the housing.

Wafers 787 (broadly “engaging members”) within the lock cylinder 781 are adapted for transverse movement relative to the cylinder between an extended position in which the wafers extend outward from the cylinder and seat in one of the internal channels 779, 780 in the lock housing 774 to engage the key lock 772 with the lock housing (thereby connecting the lock lever 713 with the locking mechanism via the key lock and lock rod), and a withdrawn position in which the wafers are unseated from the channel and drawn into the cylinder so that the key lock is disengaged from the lock housing to allow movement of the lock lever and key lock relative to the lock rod. Springs (not shown) in the lock cylinder 781 bias the wafers 787 toward their extended position. It is contemplated that a set of internal slots (not shown) aligned longitudinally within the housing 774 corresponding respectively to each of the wafers 787 may be used in place of each internal channel 779, 780 so that each wafer is adapted for seating in an individual slot, without departing from the scope of this invention.

The lock cylinder 781 has a key slot 789 (FIG. 18) therein for receiving a key 790 into the cylinder. The key 790 is configured for compressing the springs in the lock cylinder 781 upon insertion through the key slot 789 so that the wafers 787 are moved to their withdrawn position in the cylinder. As shown in FIG. 21, the key 790 is preferably a bi-directional key that can be inserted into the key slot 789 in either of the two possible orientations. The construction and operation of conventional wafer locks is well known in the industry and will not be further described herein.

Referring to FIGS. 17 and 20, the cap 782 is integrally formed with the lock cylinder 781 and extends outward over the outer end 776 of the lock housing 774. A central opening 791 in the cap 782 provides access to the key slot 789. In the preferred embodiment shown in FIG. 17, the outer end 776 of the lock housing 774 seats in a groove 792 in the bottom of the cap 782. A tongue 793 extending from the cap 782 seats within a recess 794 in the lock lever 713 to fixedly connect the lock lever to the key lock 772. The cap 782 has four arcuate, spaced apart windows 795 therein (FIG. 20). These windows 795 are positioned over the outer end 776 of the lock housing 774 so that portions of the outer end of the housing are visible through the windows.

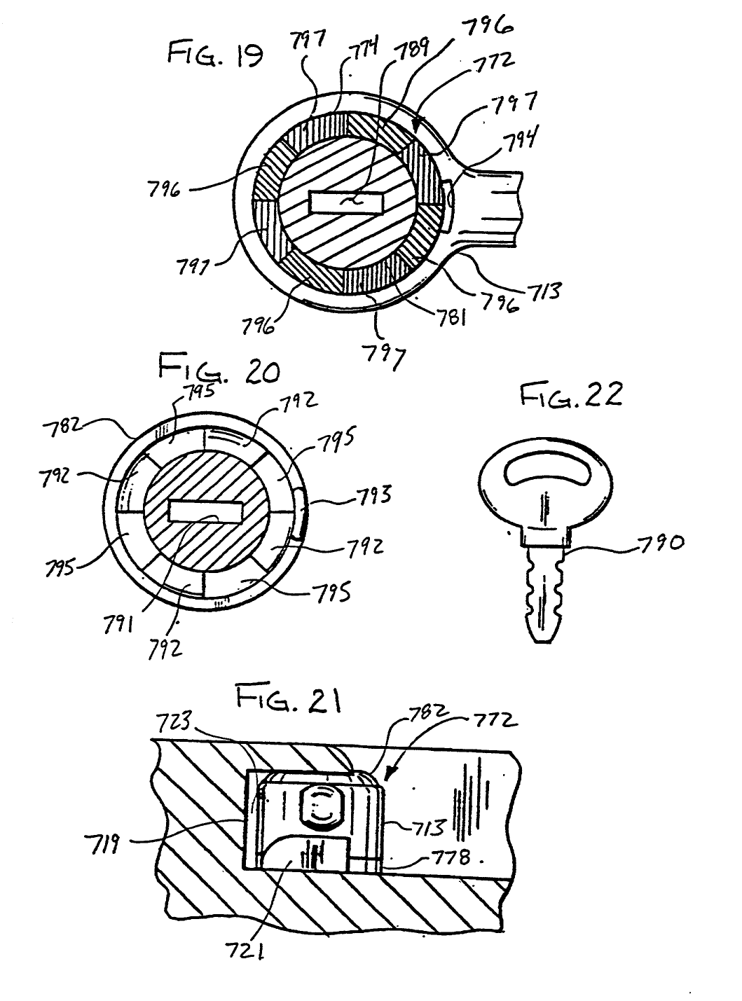

The outer end 776 of the lock housing 774 is preferably colored with alternating arcuate color segments 796, 797, as shown in FIG. 19, corresponding to the normal lock mode and guard lock mode, respectively. For example, red colored segments 796 may correspond to the normal lock mode and green colored segments 797 may correspond to the guard lock mode. The windows 795 in the cap 782 are sized for displaying one of the respective colors 796, 797 while the cap covers the other of the colors, depending on the operating mode of the locking system, so that a person within the automobile can visually identify whether the locking system is in the normal lock mode or the guard lock mode.

With reference to FIG. 15, when the locking system is in the normal lock mode, the wafers 787 in the lock cylinder 781 of the key lock 772 are in their extended position seated in the first internal channel 779 of the lock housing 774. The engagement of the wafers 787 in the channel 779 connects the key lock 772 and the lock lever 713 affixed thereto to the lock housing for conjoint movement. Thus, movement of the lock lever 713 between the unlocked position shown in solid lines in FIG. 15 and the locked position shown in phantom in FIG. 15 actuates the lock rod to lock and unlock the locking mechanism. The windows 795 in the cap 782 are aligned with the red arcuate color segments 796 of the outer end 776 of the lock housing 774 to indicate that the locking system is in the normal lock mode. Because the lock lever 713, key lock 772 and lock housing 774 move conjointly, the same color 796 appears in the windows of the cap regardless of whether the lock lever is in the locked or unlocked position.

To change the locking system from the normal lock mode to the guard lock mode, the key 790 is inserted through the cap opening 791 and key slot 789 into the lock cylinder 781 of the key lock 772. Insertion of the key 790 compresses the springs inside the lock cylinder 781, thereby unseating the wafers 787 from the first internal channel 779 of the lock housing 774 and retracting the wafers from the channel into the cylinder. The key lock 772 is thus disengaged from the lock housing 774 (and hence disengaged from the locking mechanism), and the lock lever 713 and key lock 772 may be moved conjointly with respect to the lock rod by turning the key until the key lock abuts against a stop (not shown). The wafers 787 are now aligned with the second internal channel 780 in a position corresponding to the guard lock mode. Rotation of the key lock 772 with respect to the lock housing 774 also aligns the windows 795 in the cap 782 with the green arcuate color segments 797 of the free end 776 of the lock housing to indicate that the locking system is in the guard lock mode.

Removing the key 790 from the key lock 772 allows the compressed springs to push the wafers 787 to their extended position seated in the second internal channel 780. The engagement of the wafers 787 in the channel 780 again connects the key lock 772 and the lock lever 713 affixed thereto to the lock housing 774 for conjoint movement. Thus, movement of the lock lever 713 between the unlocked position shown in solid lines in FIG. 16 and the locked position shown in phantom in FIG. 16 actuates the lock rod to lock and unlock the locking mechanism. Because the lock lever 713, key lock 772 and lock housing 774 move conjointly, the same color 797 appears in the windows 795 of the cap 782 regardless of whether the lock lever is in the locked or unlocked position. In the unlocked position, the lock lever 713 is inaccessibly positioned within the pocket 723 formed by the locking frame 719 and shield 721, and can be moved to its unlocked position only by using the power locking system 119 or by using the key 790 to adjust the lock lever back to the normal lock mode.

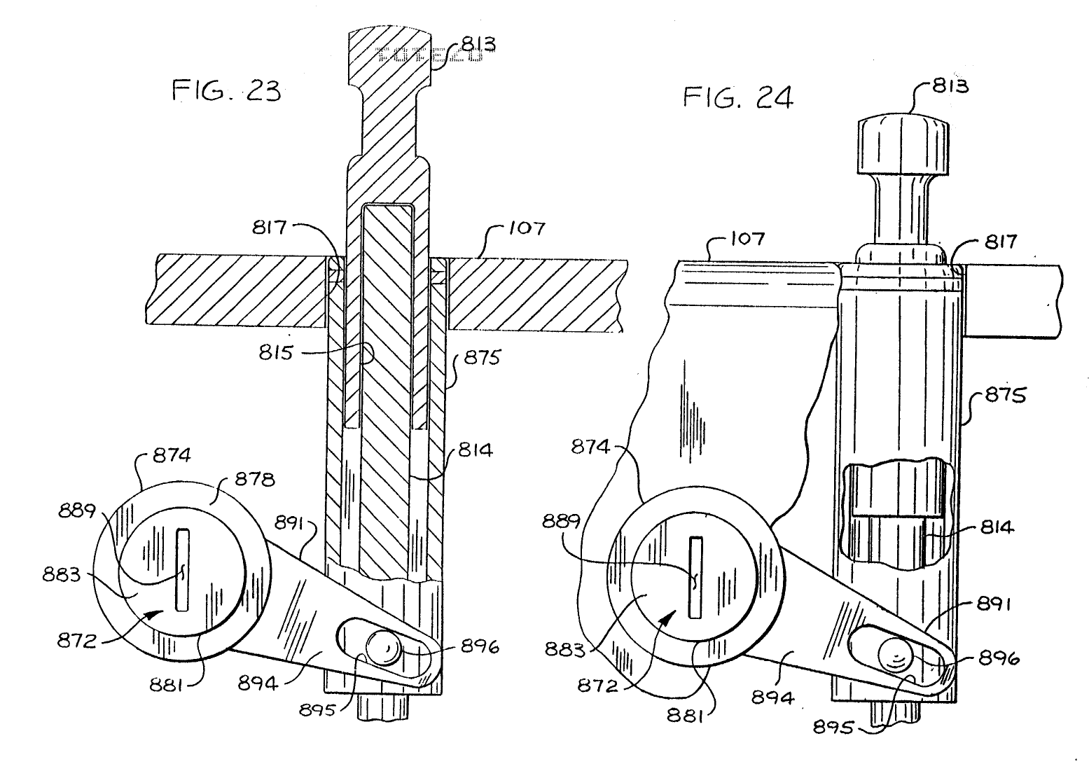

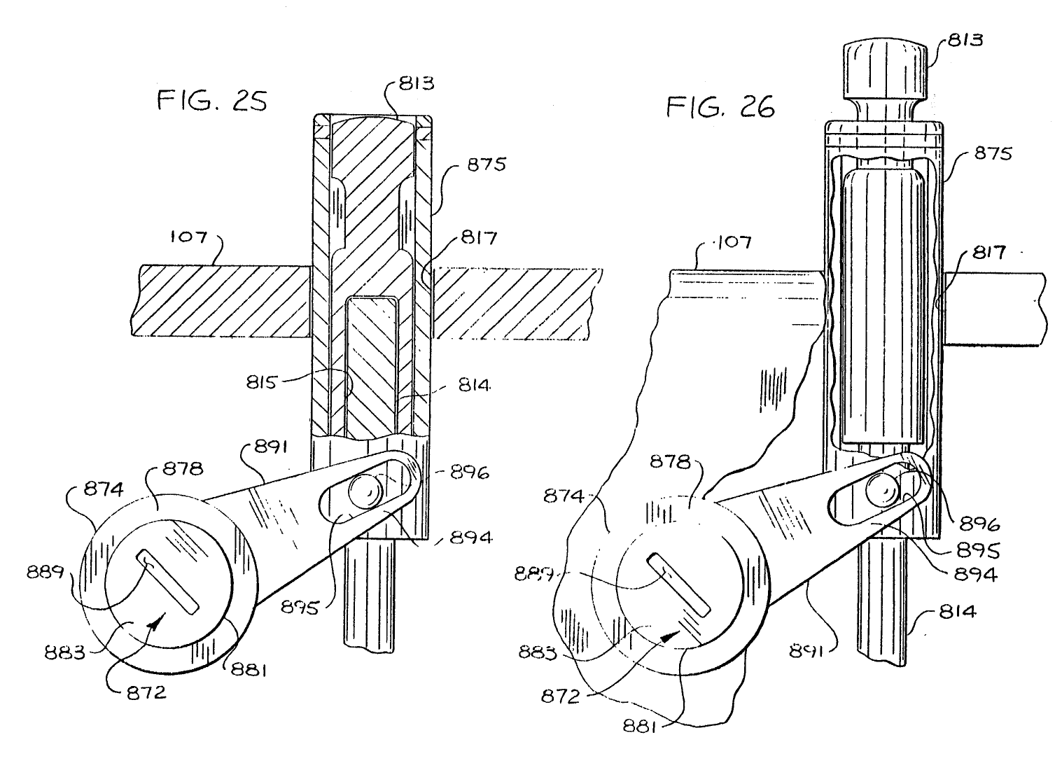

An eighth embodiment of the child-safety locking system (FIGS. 23-29) has a lock button 813 and lock rod 814 similar to that of the first and second embodiments. The location of the lock button 813 and lock rod 814 with respect to the interior door panel 107 and locking mechanism 111 may be essentially the same as shown in FIG. 1. However, the lock button 813 need not be adjustable on the lock rod 814 between normal lock and guard lock modes, as with the first and second embodiments. As shown in FIG. 23, the lock button 813 is generally cylindrical in shape and has an internal hole 815 extending up from its bottom for mounting on an end of the lock rod 814 in an opening 117 of an upward facing portion of the interior door panel 107. The other end of the lock rod 814 is connected to the locking mechanism 111 such that when the lock button 813 is pulled upward relative to the door panel 107 to its unlocked position (FIG. 23) the locking mechanism unlocks the latch 103 (FIG. 1), and when the lock button is pushed downward relative to the door panel to its locked position (FIG. 24) the locking mechanism locks the latch. While the lock button 813 is illustrated herein as being cylindrical, it is understood that the lock button may have a different cross-sectional shape without departing from the scope of this invention.

The child-safety locking system of this embodiment also incorporates my novel “Child-Key-Guard Unit” similar to that of the seventh embodiment in which a key lock, generally indicated at 872, and a lock housing 874 define adjustable mounting structure for adjusting the mode of the locking system between the normal lock mode and the guard lock mode without moving the lock button 813 relative to the lock rod 814. This embodiment also provides for visually identifying which mode the locking system is in from inside the automobile.

With reference to FIGS. 23-26, a generally tubular shield 875 is disposed vertically in the opening 117 of the upward facing portion of the interior door panel 107 around the lock button 813 and lock rod 814. As illustrated, the tubular shield 875 is cylindrical in accordance with the cylindrical shape of the lock button 813. However, the shield 875 may be of other shapes, depending on the shape of the lock button 813, without departing from the scope of this invention. The inner diameter of the shield 875 is sufficient to allow the lock button 813 and lock rod 814 to move vertically within the shield as the lock button is moved between its locked and unlocked position. The shield 875 is free of any fixed connection with the door panel 107, lock button 813 and lock rod 814. Thus, the shield 875 is capable of translating (e.g. vertical) movement relative to the door panel 107, lock button 813 and lock rod 814 between a retracted inoperative position (FIGS. 23 and 24) corresponding to the normal lock mode in which the shield is recessed into the opening 117 of the door panel and an extended operative position (FIGS. 25 and 26) corresponding to the guard lock mode in which the shield extends outward from the door panel opening. As shown in FIG. 26, the length of the shield 875 is sufficient so that in its operative position, the lock button 813 is recessed within the shield in its locked position where it is shielded against access to the lock button for manually moving the lock button to its unlocked position. The shield 875 is colored green so as to be visibly distinguishable from the lock button 813 so that a person within the interior of the automobile can visibly identify whether the shield is in its operative or inoperative position.

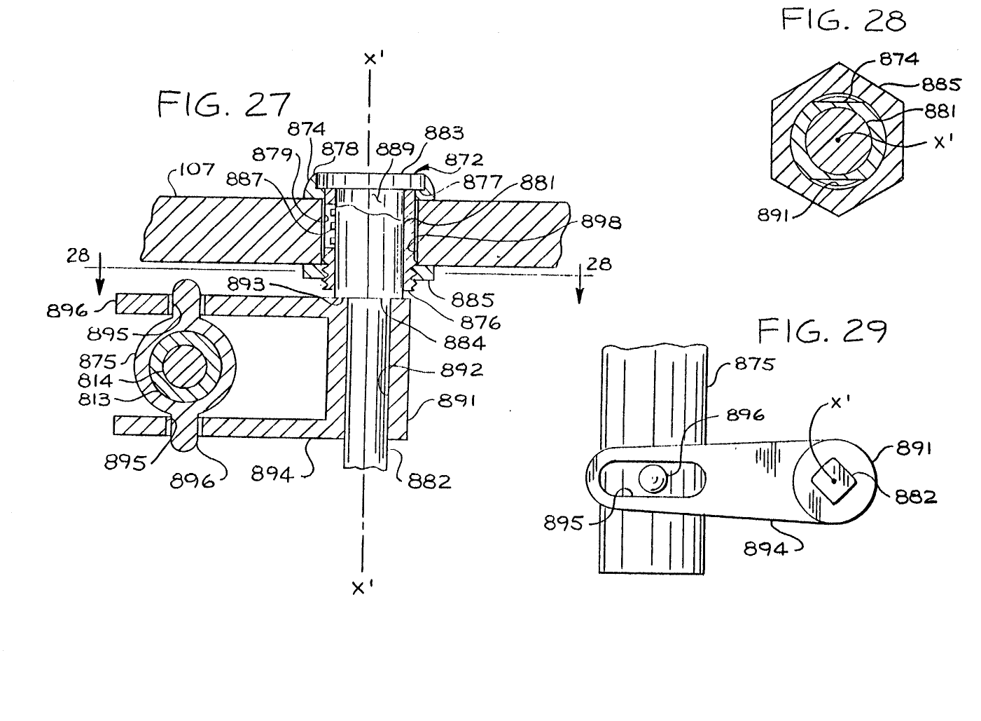

As shown in FIG. 27, the lock housing 874 is generally cylindrical and is disposed in a second opening 898 of the interior door panel 107 in spaced apart relationship with the door panel opening 117 in which the lock button 813 and shield 875 are disposed. An inner end 878 of the lock housing 874 is flanged radially outward for engaging the interior door panel 107 from within the interior of the automobile. An outer end 876 of the housing 874 is externally threaded for engagement with a lock nut 885 threaded onto the outer end of the lock housing to secure the lock housing in the second opening of the door panel. The key lock 872 is partially received in and extends through the lock housing 874. An internal shoulder 877 formed within the housing 874 adjacent its inner end 878 provides a seat for locating the key lock 872 within the housing. A pair of internal channels (only one of which is shown in FIG. 27 and designated 879, the other of which is substantially identical to that shown in FIG. 18) each extend longitudinally within the housing 874 intermediate its inner and outer ends 878,876. In the illustrated embodiment, these channels 879 are spaced apart approximately 45°. However, this spacing may vary without departing from the scope of the invention.

The key lock 872 comprises a lock cylinder 881 sized for positioning within the lock housing 874 in closely spaced relationship with the housing, and a torque extension member 882 formed integrally with an outer end 884 of the cylinder along a rotation axis X′ of the key lock and projecting longitudinally beyond the outer end 876 of the housing. An inner end 883 of the cylinder is flanged radially outward for seating against the internal annular shoulder 877 of the housing 874. The lock cylinder 881 corresponds closely in construction to a conventional wafer lock as described above with respect to the seventh embodiment. However, pin locks and other suitable locks (not shown) may be used without departing from the scope of this invention.

Wafers 887 (broadly “engaging members”) within the lock cylinder 881 are adapted for transverse movement relative to the cylinder between an extended position in which the wafers extend outward from the cylinder and seat in one of the internal channels 879 in the lock housing to rotationally fix the key lock 872 with respect to the lock housing 874, and a withdrawn position in which the wafers are unseated from the channel and drawn into the cylinder so that the key lock is disengaged from the lock housing to allow rotation of the key lock about its rotation axis X′ relative to the housing. Springs (not shown) in the lock cylinder 881 bias the wafers 887 toward their extended position. It is contemplated that a set of internal slots (not shown) aligned longitudinally within the housing 874 corresponding respectively to each of the wafers 887 may be used in place of each internal channel 879 so that each wafer is adapted for seating in an individual slot, without departing from the scope of this invention.

The lock cylinder 881 has a key slot 889 (substantially identical to the key lock shown in FIG. 18) therein for receiving a key 790 (FIG. 22) into the cylinder. The key slot 889 is on the inner end 883 of the lock cylinder 881 and is accessible for inserting the key 790 from the interior of the automobile into the lock cylinder. The key 790 is configured for compressing the springs in the lock cylinder 881 upon insertion through the key slot 889 so that the wafers 887 are moved to their withdrawn position in the cylinder. The lock cylinder 881 is free to turn in the housing 874 when the wafers 887 are withdrawn from the channels 879. As shown in FIG. 21, the key 790 is preferably a bi-directional key that can be inserted into the key slot 889 in either of the two possible orientations. The construction and operation of conventional wafer locks is well known in the industry and will not be further described herein.

As seen best in FIG. 29, the torque extension member 882 is rectangular in cross-section. The torque extension member 882 is received in a lever 891 having an opening 892 in coaxial alignment with the rotation axis X′ of the key lock 872. The opening 892 is sized and shaped according to the cross-sectional shape of the torque extension member 882 for receiving the extension member in close-fitting relationship. Thus, turning the key lock 872 about its rotation axis X′ conjointly pivots the lever 891.

In the illustrated embodiment, the width of the torque extension member 882 is less than the diameter of the lock cylinder 881, defining a shoulder 893 at the outer end 884 of the lock cylinder. The lever 891 is mounted on the torque extension member 882 and seats against the shoulder 893. The torque extension member 882 extends through the opening 892 of the lever 891 and projects outward of the lever. A suitable fastener (not shown), such as a cotter or dowel pin, extends transversely through the torque extension member 882 adjacent the lever 891 to secure the lever on the torque extension member. The fastener also prevents movement of the key lock 872 out of the inner end 878 of the lock housing 874.

The lever 891 has a pair of lever arms 894 extending transversely with respect to the torque extension member 882 in generally parallel spaced apart relationship with each other. Each of the lever arms 894 has a slot 895 therein located distally from the torque extension member 882. These slots 895 are sized for receiving respective pins 896 extending radially outward from the shield 875 adjacent the lower end of the shield. The spacing between the lever arms 894 is substantially the same as the outer diameter of the shield 875. The lever arms 894 are strong and yet sufficiently flexible and resilient for bending outwardly away from one another for seating the pins 896 within the slots 895 and then returning to their undeflected position in closely spaced relationship with the shield 875 whereby the pins extend through the slots in the lever to 891 connect the lever to the shield. The key lock 872 is thus operatively connected to the shield 875 via the lever 891 so that turning the key lock 872 about its rotation axis X′ effects translational movement of the shield between its inoperative and operative positions. The slots 895 in the lever arms 894 are sufficiently long to allow the pins 896 of the shield 875 to slide longitudinally within the slots as the shield is translated relative to the rotating key lock 872 and lever 891.

With reference to FIGS. 23 and 24, when the locking system is in the normal lock mode, the wafers 887 in the lock cylinder 881 of the key lock 872 are in their extended position seated in the first internal channel 879 of the lock housing 874. The engagement of the wafers 887 in the channel 879 secures the shield 875 in its inoperative position within the opening 117 of the interior door panel 107. Thus the lock button 813 is accessible for being grasped by a person's fingers to move the lock button between its locked and unlocked positions for locking and unlocking the locking mechanism 111. Because the green colored shield 875 is recessed within the door panel 107, only the lock button 813 is visible within the interior of the automobile to indicate that the locking system is in the normal lock mode.

To change the locking system from the normal lock mode to the guard lock mode, the key 790 is inserted through the key slot 889 into the lock cylinder 881 of the key lock 872. Insertion of the key 790 compresses the springs inside the lock cylinder 881, thereby unseating the wafers 887 from the first internal channel 879 of the lock housing 874 and retracting the wafers from the channel into the cylinder. The key lock 872 is thus disengaged from the lock housing 874 and may be rotated about its rotation axis X′ until it abuts against a stop (not shown). As the key lock 872 is rotated, the torque extension member 882 applies sufficient torque to the lever 891 to pivot the lever arms 894 about the key lock rotation axis X′. The lever arms 894 push upward on the shield 875, thereby moving the shield to its operative position exterior of the door panel opening 117. As the shield 875 is moved to its operative position, the pins 896 of the shield 875 slide longitudinally within the slots 895 in the lever arms 894 to allow the lever 891 to rotate as the shield moves tranislationally.

When the key lock 872 abuts the stop, the wafers 887 are aligned with the second internal channel in a position corresponding to the guard lock mode. Removing the key 790 from the key lock 872 allows the compressed springs to urge the wafers 887 to their extended position seated in the second internal channel for securing the locking system in its guard lock mode. With the shield 875 secured in its operative position, the lock button 813 extends slightly outward of the shield in its unlocked position so that it is accessible for manual manipulation to its locked position. The person places a finger on top of the button 813 and applies sufficient force to move the lock button down to its locked position. In this position, the lock button 813 is fully recessed within the shield 875 so that the lock button is inaccessible for manual movement back to its unlocked position. Only the green color of the shield 875 is visible within the interior of the automobile to indicate that the locking system is operating in the guard lock mode.

To unlock the locking mechanism when the locking system is in the guard lock mode, the power locking system 119 (FIG. 14) may be used to actuate the lock button 813 to move the lock button to its unlocked position. Alternatively, the key 790 may be used to move the shield 875 to its inoperative position so that the locking system is returned to the normal lock mode as described above.

While the shield 875 illustrated in the above embodiment is cylindric, it is contemplated that the shield may be other than cylindric without departing from the scope of this invention. For example, the shield 875 may be polygonal, or be semi-cylindric and in closely spaced relationship with a portion of the interior door panel 107 in its operative position so that the lock button 813 is shielded in its locked position between the shield and the interior door panel. However, the shield 875 should preferably be shaped to achieve a closely spaced relation with the lock button 813.

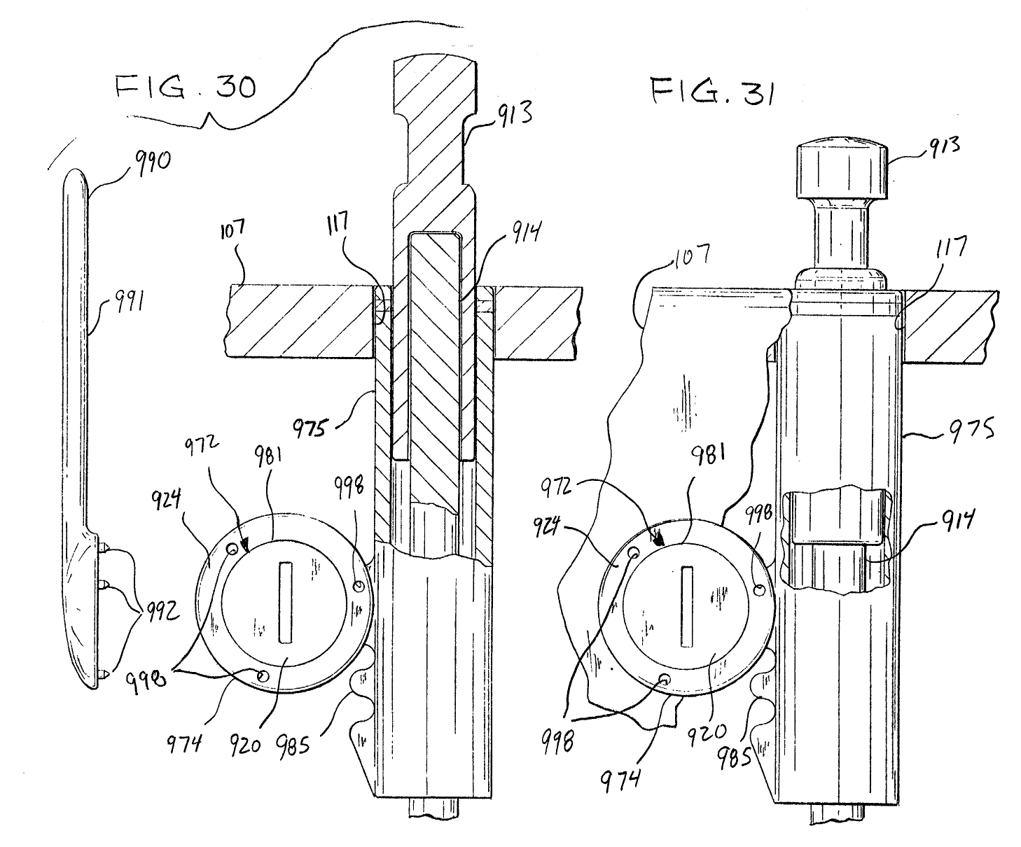

FIGS. 30-34 illustrate a ninth embodiment of the child-safety locking system of the present invention which is substantially similar to the eighth embodiment described above including a lock button 913 mounted on a lock rod 914. A key lock, generally indicated at 972, and lock housing 974 together define adjustable mounting structure for adjusting the mode of the locking system between a normal lock mode and a guard lock mode without moving the lock button 913 relative to the lock rod 914. This embodiment also provides for visually identifying which mode the locking system is in from inside the automobile in the same manner as the eighth embodiment.

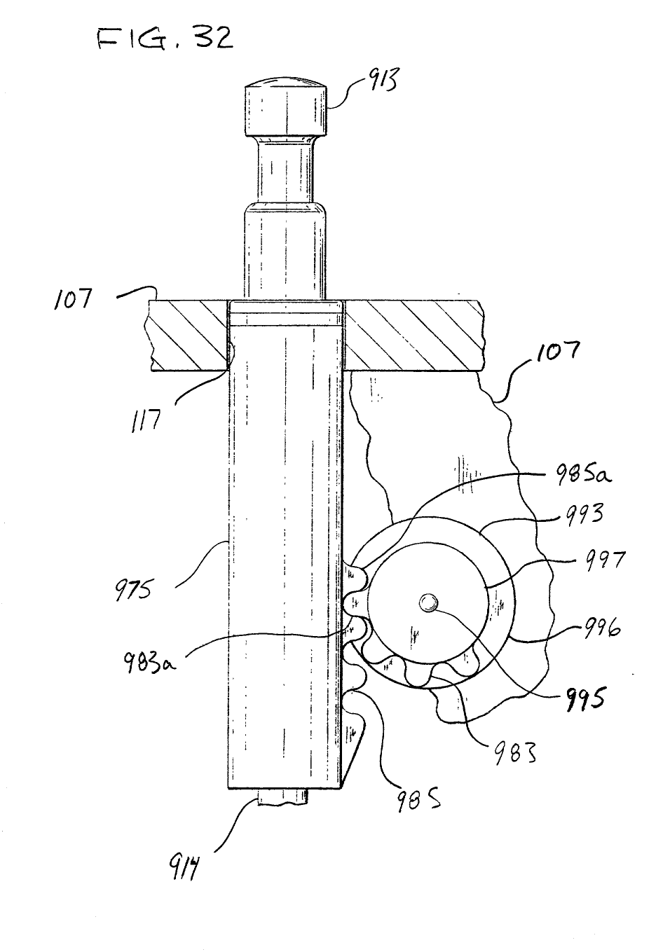

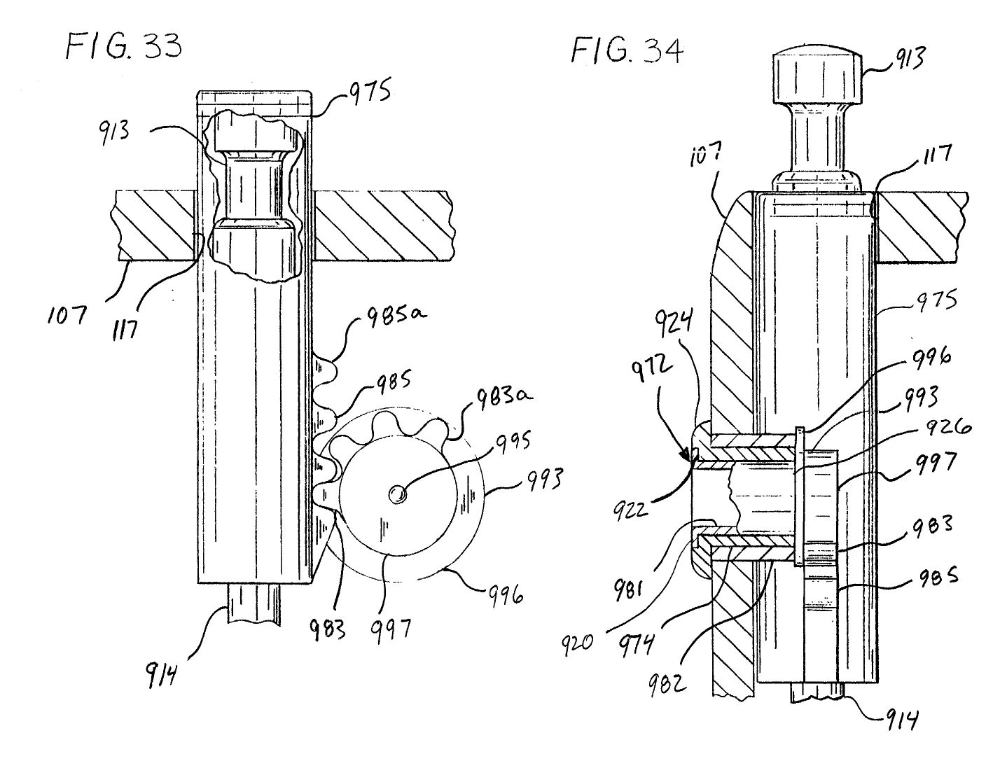

A generally tubular shield 975 is disposed vertically in the opening 117 of the upward facing portion of the interior door panel 107 around the lock button 913 and lock rod 914. As illustrated, the tubular shield 975 is cylindrical in accordance with the cylindrical shape of the lock button 913. However, the shield 975 may be of other shapes, depending on the shape of the lock button 913, without departing from the scope of this invention. The inner diameter of the shield 975 is sufficient to allow the lock button 913 and lock rod 914 to move vertically within the shield as the lock button is moved between its locked position (FIGS. 31,33,34) and unlocked position (FIGS. 30, 32). The shield 975 is free of any fixed connection with the door panel 107, lock button 913 and lock rod 914. Thus, the shield 975 is capable of linear (e.g. vertical) movement relative to the door panel 107, lock button 913 and lock rod 914 between a retracted inoperative position (FIGS. 30-32, 34) corresponding to the normal lock mode in which the shield is recessed into the opening 117 of the door panel and an extended operative position (FIG. 33) corresponding to the guard lock mode in which the shield extends outward from the door panel opening. As shown in FIG. 33, the length of the shield 975 is sufficient so that in its operative position, the lock button 913 is recessed within the shield in its locked position where it is shielded against access to the lock button for manually moving the lock button to its unlocked position. The shield 975 is colored green or otherwise as to be visibly distinguishable from the lock button 913 so that a person within the interior of the automobile can visibly identify whether the shield is in its operative or inoperative position.

With further reference to FIG. 33, the shield 975 of this ninth embodiment is operatively connected to the key lock 972 in a generally rack and pinion connection whereby rotation of the key lock effects linear movement of the shield between its operative and inoperative positions. The key lock 972 is substantially the same as the key lock 872 of the eighth embodiment, comprising a lock cylinder 981 sized for positioning within a lock housing 974 in closely spaced relationship with the housing and capable of rotation within the housing about a rotation axis of the lock cylinder. As shown in FIG. 34, an outer end 920 of the lock cylinder 981 is flanged for seating against a recessed shoulder 922 of the lock housing 974 to axially position the lock cylinder in the housing. The lock housing 974 also has a flanged outer end 924 for seating against the side of the interior door panel 107. A tubular sleeve 982 in the door panel 107 is sized for receiving the lock housing 974 in frictional engagement therewith to inhibit rotation of the lock housing relative to the door panel 107. The key lock 972 further includes a generally discus plate member 993 secured to an inner end 926 of the lock cylinder 981 by a suitable fastener 995 inward of the lock housing 974 for conjoint rotation with the lock cylinder relative to the lock housing. The plate member 993 includes a cover plate 996 sized radially larger than the lock housing 974 and tubular sleeve 982 so that, upon being fastened to lock cylinder, the cover plate abuts against the housing and sleeve to axially secure the lock cylinder 981, lock housing and tubular sleeve in the door panel 107.

In the illustrated embodiment, the plate member 993 also includes a gear plate 997 having four gear teeth 983, broadly defining a pinion, extending generally radially outward therefrom for conjoint rotation with the key lock 972. The number of gear teeth 983 may vary, however, and may even be limited to a single gear tooth, depending on the desired longitudinal travel of the shield 975. It is also contemplated that the gear plate 997 may be omitted, with the gear teeth 983 extending radially outward from the cover plate 996, or from the inner end 926 of the lock cylinder 981, without departing from the scope of this invention, as long as the gear teeth are conjointly rotatable with the lock cylinder. Corresponding gear teeth 985 are attached to the shield 975 and extend generally laterally outward from a lower portion of the shield in the door panel 107 to define a rack. The gear teeth 985 of the shield 975 are spaced longitudinally with respect to each other for interengagement with the gear teeth 983 of the key lock 972. In the illustrated embodiment, the gear teeth 985 are centrally positioned on the side of the shield 975 to extend radially outward from the shield. Alternatively, the gear teeth 985 may extend laterally outward from the shield 975 in a manner other than radially, such as generally tangentially to the shield. The term laterally as used herein in reference to the gear teeth 985 is intended to include not only a perpendicular extension of the gear teeth relative to the shield 975 but also any outward extension relative to the shield having a lateral component, such as where the gear teeth are angled relative to the shield to extend upward and outward or downward and outward from the shield.

The key lock 972 is thus operatively connected to the shield 975 by the rack and pinion connection wherein the gear teeth 983 of the key lock 972 interengage the gear teeth 985 of the shield 975. To change the locking system from the normal lock mode to the guard lock mode, the key 790 (FIG. 22) is inserted into the lock cylinder 981 as in prior embodiments to disengage the key lock 972 from the lock housing 974 to permit rotation of the key lock relative to the housing to the guard lock mode of the locking system. As the key lock 972 is rotated, the gear teeth 983 of the key lock rotate about the rotation axis of the key lock to sequentially interengage the corresponding gear teeth 985 attached to the shield 975 for lifting or otherwise pushing upward on the shield, thereby effecting linear movement of the shield to its operative position exterior of the door panel opening 117. The lock button 913 is then manually pushed downward to its locked position within the shield 975 so that the lock button is fully recessed within the shield and is inaccessible for manual movement back to its unlocked position.

As in the previously described embodiments incorporating a key lock, internal channels (not shown, but similar to internal channels 887 of FIG. 27) in the lock housing 974 respectively corresponding to the normal and guard lock modes receive wafers (not shown) of the lock cylinder 981 of the key lock 972 to secure the key lock in the normal and guard lock modes. In this ninth embodiment, the longitudinal travel of the shield 975 between its inoperative and operative positions is a function of the angular spacing between the internal channels of the lock housing 974, e.g., the angle through which the key lock 972 is rotated in switching from the normal lock mode to the guard lock mode of the locking system. The channels of the illustrated embodiment are angularly spaced to permit rotation of the key lock 972 through about a 90° rotation. The longitudinal position of the actuator shield 975 relative to the door panel 107 and lock button 913, in both the operative and inoperative positions of the shield, depends on the initial positioning of the key lock gear teeth 983 relative to the gear teeth 985 of the actuator shield. For example, to achieve the uppermost longitudinal position of the shield 975 in its operative position, the first gear tooth of the key lock (e.g., gear tooth 983a in FIG. 32) must be positioned for interengagement with the uppermost gear tooth (e.g., gear tooth 985a) of the actuator shield when the key lock 972 is in its normal lock mode and the shield is in its inoperative position. This permits substantially all of the key lock gear teeth 983 to interengage the shield gear teeth 985 upon rotation of the key lock 972 to the guard lock mode of the locking system for pushing the shield 975 upward relative to the door panel 107.

As such, the key lock housing 974 of the illustrated embodiment is positioned in the tubular sleeve 982 so that when the wafers of the key lock cylinder 981 seat in the internal channel of the housing corresponding to the normal lock mode, the first gear tooth 983a of the key lock 972 interengages the uppermost gear tooth 985a of the shield 975. To adjust the position of the key lock housing 974 upon installation in the tubular sleeve 982, an installation tool 990 (FIG. 30) is provided for rotating the lock housing relative to the tubular sleeve against the frictional engagement between the sleeve and the housing. The tool 990 is a wrench-type tool comprising a lever arm 991 and three pins 992 protruding laterally outward from an end of the lever arm in spaced relationship with each other. Corresponding openings 998 are formed in the flanged outer end 924 of the lock housing 974 in spaced relationship with each other for receiving the pins 992 of the installation tool 990 whereby rotation of the tool effects rotation of the lock housing relative to the tubular sleeve 982 to permit proper rotational positioning of the internal channels of the lock housing.

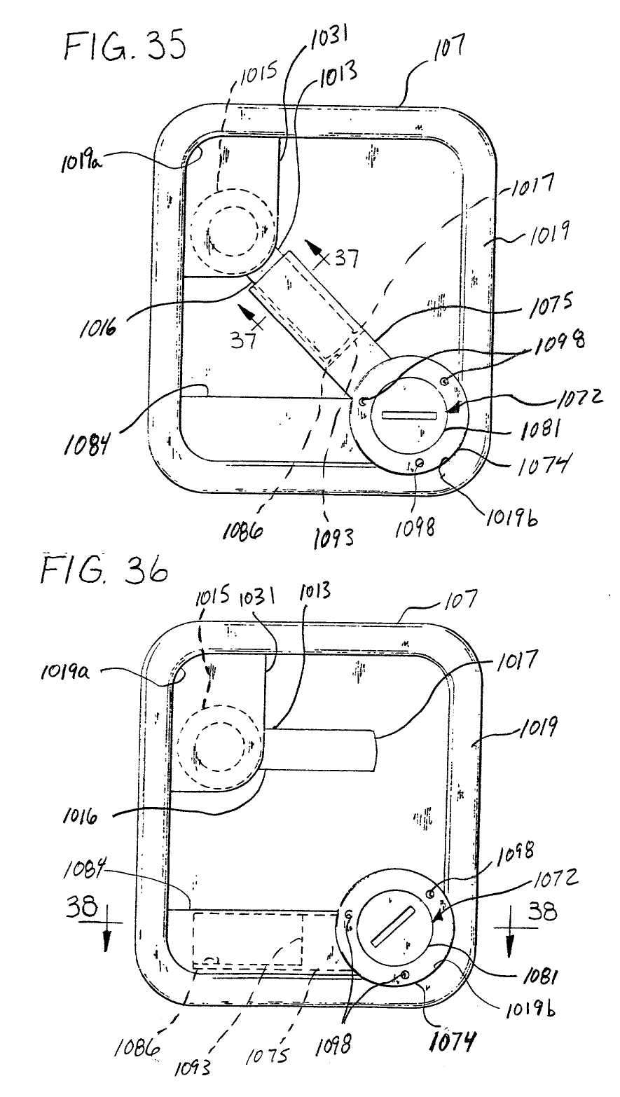

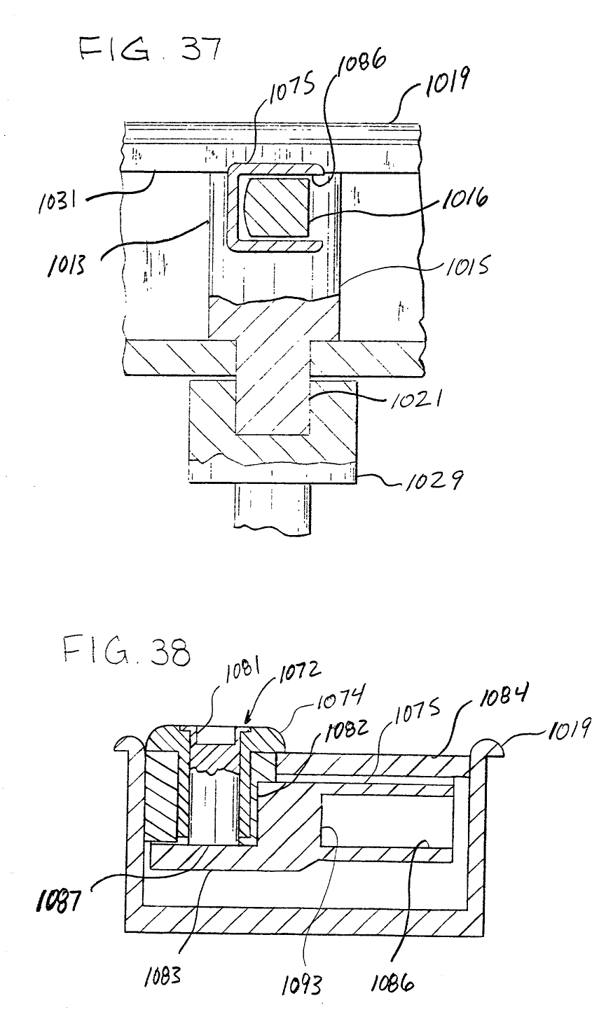

FIGS. 35-38 illustrate a tenth embodiment of the child-safety locking system in which the lock actuator 1013 is a lock lever similar to that of the third embodiment described above (FIGS. 5-7). With particular reference to FIGS. 35 and 37, the lock lever 1013 has a cylindrical body 1015 and a lever 1016 extending generally radially outward from the body. The lock lever 1013 is mounted on the side of the interior door panel 107 in a locking frame 1019 (constituting part of the door panel in this embodiment) which is recessed into the remainder of the door panel. An extension member 1021 (FIG. 37) extending axially inward from the inner end of the lock lever body 1015 extends into the interior of the door and is operatively connected to a lock stud 1029 for conjoint rotation of the lock lever 1013 and lock stud about the longitudinal axis of the lock stud. The lock stud 1029 extends within the interior of the door for connection, by way of a lock rod (not shown), to the locking mechanism (not shown).

The lock lever 1013 is rotatable between a locked position (shown in phantom in FIG. 35) in which the latch on the door is locked and an unlocked position (FIG. 36) in which the latch on the door is unlocked. In the illustrated embodiment, the lock lever body 1015 is positioned generally adjacent a corner 1019a of the locking frame 1019. In the locked position of the lock lever 1013, the lever 1016 extends generally diagonally within the locking frame 1019 from the corner 1019a in which the lock lever body 1015 is positioned. Rotation of the lock lever 1013 operates the locking mechanism to lock and unlock the latch (not shown). A cover panel 1031 is attached to the locking frame 1019 over the lock lever body 1015 so that the lock lever body is held between the cover panel and the locking frame 1019 to secure the lock lever 1013 on the lock stud 1019.

With reference to FIGS. 35 and 38, the child-safety locking system of this tenth embodiment also includes a key lock, generally indicated at 1072 and lock housing 1074, which together broadly define adjustable mounting structure for adjusting the mode of the locking system between the normal lock mode and the guard lock mode, and a lock actuator shield 1075. The lock housing 1074 and key lock 1072 are substantially similar to those disclosed above with respect to the seventh embodiment (FIGS. 15-22). A tubular sleeve 1082 is sized for receiving the lock housing 1074 in frictional engagement therewith to inhibit rotation of the lock housing relative to the door panel 107. In the illustrated embodiment, the lock housing 1074 and key lock 1072 are positioned adjacent a corner 1019b of the locking frame 1019 diagonally opposite the corner 1019a in which the lock lever body 1015 is positioned. However, it is understood that the lock lever body 1015 and lock housing 1074 may be disposed adjacent opposing sides of the locking frame 1019, instead of the corners 1019a, 1019b without departing from the scope of this invention. The key lock 1072 seats in the lock housing 1074 and is rotatable in the lock housing about the longitudinal axis of the key lock between the normal lock mode and the guard lock mode.

As shown in FIG. 38, a torque member 1083 is connected by suitable fastener (not shown) to an inner end 1087 of the key lock 1072 axially inward of the lock housing 1074. The torque member 1083 extends radially outward beyond the key lock 1072, lock housing 1074 and tubular sleeve 1082 so that connection of the torque member to the key lock secures the key lock, lock housing and sleeve in the locking frame 1019. The lock actuator shield 1075 is attached to the torque member 1083 and extends radially outward therefrom to extend generally centrally into the locking frame 1019. In the illustrated embodiment the torque member 1083 and shield 1075 are of unitary construction. However, these components may instead be formed separately and connected together with suitable fasteners. Attachment of the shield 1075 to the torque member 1083 operatively connects the shield with the key lock 1072 for conjoint rotation of the shield with the key lock relative to the lock housing 1074 between an extended, operative position corresponding to the guard lock mode in which the actuator shield extends generally diagonally into the locking frame 1019 in substantially axial alignment with the lock lever 1013 when the lock lever is in its locked position and a retracted, inoperative position corresponding to the normal lock mode in which the actuator shield is positioned away from the lock lever when the lock lever is in its locked position. The length of the shield 1075 is sufficient to extend generally to adjacent the lock lever body 1015 and the cover panel 1031 covering the lock lever body in the guard lock mode of the locking system to prevent a finger from being inserted between the shield and the lock lever body to move the lock lever 1013 or the shield. In the illustrated embodiment, a shield cover 1084 is attached to the locking frame 1019 to define a pocket in which the actuator shield 1075 is received in the normal lock mode of the locking system. However, the shield cover 1084 is not necessary to the operation of the locking system.

The actuator shield 1075 is configured for receiving the lever 1016 of the lock lever 1013 into the shield in the guard lock mode of the locking system. As shown in FIG. 37, a portion of the actuator shield 1075 is generally C-shaped in cross-section to define a receiving channel 1086 sized for receiving the lever 1016 into the shield in closely spaced relationship with the shield.

The length of the channel 1086 is such that an outer end 1017 of the lever 1016 (FIG. 35) is in closely spaced relationship with an inner end 1093 (FIGS. 35 and 38) of the channel when the locking system is in the guard lock mode and the lock lever is in its locked position. Thus, a finger cannot be inserted between the shield 1075 and the lock lever 1013 to move the lock lever out of the channel 1086 or to move the shield away from the lock lever when the locking system is in the guard lock mode. It is understood that the shape of the shield 1075, and more particularly the receiving channel 1086, may be other than C-shaped without departing from the scope of this invention, as long as the channel is capable of receiving the lever 1013 into the actuator shield in closely spaced relationship therewith to prevent a finger from being inserted between the shield and the lock lever in the guard lock mode of the locking system.

As in the previously described embodiments incorporating a key lock, internal channels (not shown but similar to internal channels 887 of FIG. 27) in the lock housing 1074 are spaced from each other to respectively correspond to the normal and guard lock modes. The channels receive wafers (not shown) of the lock cylinder 1081 to secure the key lock 1072 in the normal and guard lock modes. For example, in the illustrated embodiment the channels are angularly spaced to permit rotation of the key lock 1072 through a 45° rotation, thereby rotating the shield 1075 through the same rotation angle between the inoperative and operative positions of the shield. In this tenth embodiment, it is important that the key lock housing 1074 be rotationally positioned in the tubular sleeve 1082 so that the actuator shield 1075 is properly aligned with the lock lever 1013 for receiving the lock lever in its locked position when the key lock wafers seat in the internal channel corresponding to the guard lock mode. To adjust the position of the key lock housing 1074 in the tubular sleeve 1082, an installation tool (not shown but substantially similar to the tool 990 show in FIG. 30) is provided for rotating the lock housing relative to the tubular sleeve and locking frame 1019 against the frictional engagement by the sleeve. As described above with respect to the previous embodiment, the tool 990 is a wrench-type tool comprising a lever arm 991 and three pins 992 protruding laterally outward from an end of the lever arm in spaced relationship with each other. Corresponding openings 1098 are formed in an outer end 1024 of the lock housing 1074 in spaced relationship with each other for receiving the pins 992 of the installation tool 990 whereby rotation of the tool effects rotation of the lock housing relative to the tubular sleeve 1082 to permit proper rotational positioning of the internal channels of the lock housing.

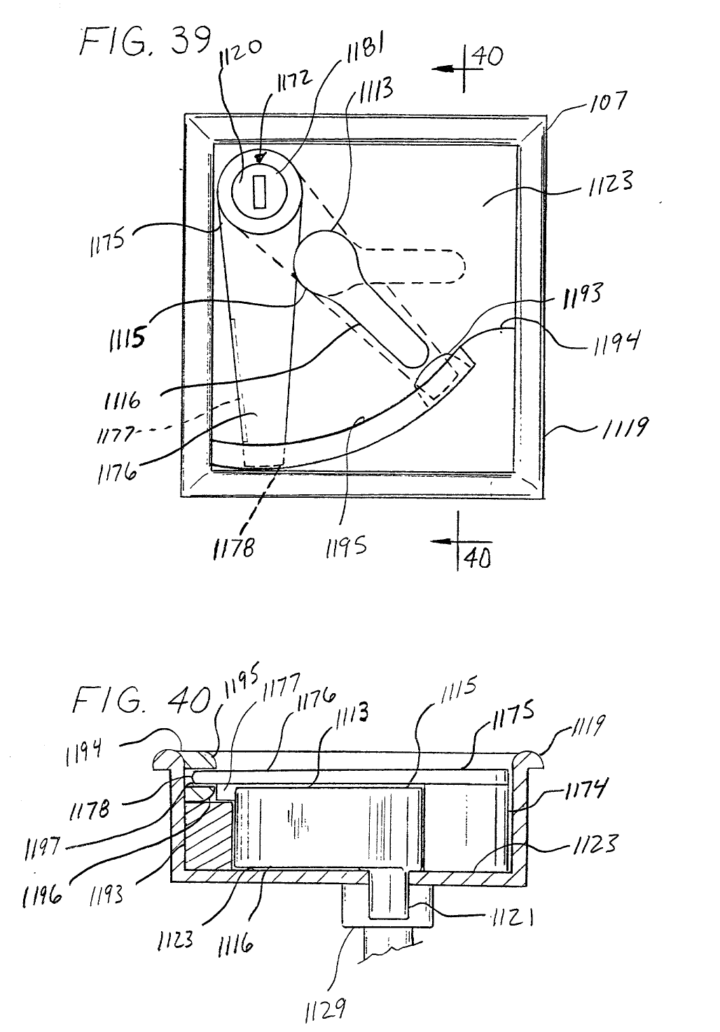

FIGS. 39-40 illustrate an eleventh embodiment of the child-safety locking system in which the lock actuator 1113 is a lock lever similar to that of the previous (i.e., tenth) embodiment. In this embodiment, the lock lever 1113 has a cylindrical body 1115 and a lever 1116 extending generally radially outward from the body. The lock lever 1113 is mounted on the side of the interior door panel 107 in a locking frame 1119 (constituting part of the door panel in this embodiment) which is recessed into the door panel. An extension member 1121 extending axially inward from the inner end of the lock lever body 1115 extends into the interior of the door and is operatively connected to a lock stud 1129 for conjoint rotation of the lock lever 1113 and lock stud about the longitudinal axis of the lock stud. The lock stud 1029 extends within the interior of the door for connection, by way of a lock rod (not shown), to the locking mechanism (not shown).

The lock lever 1113 is rotatable relative to the door panel 107 between a locked position in which the latch on the door is locked and an unlocked position (shown in phantom in FIG. 39) in which the latch on the door is unlocked. In the illustrated embodiment, the lock lever body 1115 is positioned generally centrally within the locking frame 1119. In the locked position of the lock lever 1113, the lever extends generally diagonally within the locking frame 1119 from the lock lever body 1115. Rotation of the lock lever 1113 operates the locking mechanism to lock and unlock the latch (not shown). As shown in FIG. 40, the lever 1116 of this embodiment has a thickness substantially equal to the axial length of the lock lever body 1115 so that the lock lever 1113 is in closely spaced relationship with a recessed surface 1123 of the locking frame 1119. A stop member 1193 is secured to the locking frame 1119 in opposed, closely spaced relationship with the lock lever 1113 when the lock lever is in its locked position to prevent a finger from being inserted between the stop member and the lock lever to move the lock lever back to its unlocked position. In the normal lock mode the lock lever 1113 is still accessible for movement back to its unlocked position.

The child-safety locking system of this eleventh embodiment also includes a key lock, generally indicated at 1172 and lock housing 1174, which together broadly define adjustable mounting structure for adjusting the mode of the locking system between the normal lock mode and the guard lock mode, and a lock actuator shield 1175. The lock housing 1174 and key lock 1172 are substantially similar to those disclosed above with respect to the seventh embodiment (FIGS. 15-22) and tenth embodiment (FIGS. 35-38) and will not be further described herein except to the extent necessary to further disclose this embodiment. The lock housing 1174 and key lock 1172 are positioned intermediate a corner 1119a of the locking frame 1119 and the lock lever body 1115. The key lock 1172 seats in the lock housing 1174 and is rotatable in the lock housing about the longitudinal axis of the key lock between the normal lock mode and the guard lock mode.

In the illustrated embodiment, an outer end 1120 of a lock cylinder 1181 of the key lock 1172 extends outward beyond an outer end 1124 of the lock housing 1174. The lock actuator shield 1175 comprises a generally thin covering plate 1176 attached to the outer end 1120 of the lock cylinder 1181. A shield panel 1177 extends inward from a portion of the covering plate 1176 in closely spaced relationship with the recessed surface 1123 of the locking frame 1119. Attachment of the shield 1175 to the lock cylinder 1181 operatively connects the shield with the key lock 1172 for conjoint rotation with the key lock relative to the lock housing 1174 and door panel 107 between an extended, operative position corresponding to the guard lock mode in which the covering plate 1176 of the shield extends generally diagonally into the locking frame 1119 in substantially parallel alignment with the lock lever 1113 in closely spaced relationship above the lock lever when the lock lever is in its locked position and a retracted, inoperative position corresponding to the normal lock mode in which the actuator shield is positioned away from the lock lever when the lock lever is in its locked position. The covering plate 1176 is sufficiently long so that in the operative position, the covering plate extends axially beyond the lever 1116 to cover the entire outer surface of the lever when the lock lever 1113 is in its locked position. The length of the shield panel 1177 is slightly longer than the length of the lever 1116 so that in the guard lock mode, the shield panel covers substantially the entire back of the lever in closely spaced relationship therewith so that in the locked position of the lock lever 1113, a finger cannot be inserted behind the shield 1175 to push the lock lever to its unlocked position.

A cover 1194 is attached to the locking frame 1119 generally opposite the positions of the lock lever 1172 and lock housing 1174. As shown in FIG. 40, a portion of the cover 1194 forms an outer bracket 1195. An inner bracket 1196 is attached to the locking frame 1119 in generally parallel spaced relationship with the outer bracket to define a channel 1197 therebetween. The channel 1197 is sized for receiving an end 1178 of the covering plate 1176 of the shield 1175 for inhibiting a finger from being inserted between the covering plate 1176 and the locking frame 1119 to move the shield to its inoperative position. The outer and inner brackets 1195, 1196 are generally arcuate in accordance with the arcuate path of rotation of the end 1178 of the shield covering plate 1176 so that the covering plate remains in the channel 1197 throughout movement of the shield between its operative and inoperative positions.

FIGS. 41-45 illustrate a twelfth embodiment of the child-safety locking system of the present invention which is substantially similar to the ninth embodiment described above including a lock button 1213 mounted on a lock rod 1214. In this twelfth embodiment, the lock button 1213 and lock rod 1214 are oriented generally horizontally and the outer surface of the interior door panel 107 has a recessed pocket 1216 formed therein and an opening 1217 in the pocket through which the lock button projects generally horizontally exterior of the door panel within the pocket. A key lock, generally indicated at 1272, and lock housing 1274 together define adjustable mounting structure for adjusting the mode of the locking system between a normal lock mode and a guard lock mode without moving the lock button 1213 relative to the lock rod 1214. This embodiment also provides for visually identifying which mode the locking system is in from inside the automobile in the same manner as the eighth embodiment.

A generally tubular shield 1275 is disposed horizontally in the opening 1217 of the pocket 1216 of the interior door panel 107 around the lock button 913 and lock rod 914. As illustrated, the tubular shield 1275 is cylindrical in accordance with the cylindrical shape of the lock button 1213. However, the shield 1275 may be of other shapes, depending on the shape of the lock button 1213, without departing from the scope of this invention. The inner diameter of the shield 1275 is sufficient to allow the lock button 1213 and lock rod 1214 to move longitudinally within the shield as the lock button is moved between its locked position (FIGS. 42, 44, 45) and unlocked position (FIGS. 41, 43). The shield 1275 is free of any fixed connection with the door panel 107, lock button 1213 and lock rod 1214. Thus, the shield 1275 is capable of linear (e.g. horizontal) movement relative to the door panel 107, lock button 1213 and lock rod 1214 between a retracted inoperative position (FIGS. 41-43, 45) corresponding to the normal lock mode in which the shield is recessed into the opening 1217 of the door panel and an extended operative position (FIG. 44) corresponding to the guard lock mode in which the shield extends outward from the door panel opening generally within the pocket 1216. As shown in FIG. 44, the length of the shield 1275 is sufficient so that in its operative position, the lock button 1213 is recessed within the shield in its locked position where it is shielded against access to the lock button for manually moving the lock button to its unlocked position. The shield 1275 is colored green or otherwise as to be visibly distinguishable from the lock button 1213 so that a person within the interior of the automobile can visibly identify whether the shield is in its operative or inoperative position.

With further reference to FIG. 44, the shield 1275 of this twelfth embodiment is operatively connected to the key lock 1272 in a generally rack and pinion connection similar to that of the ninth embodiment described above whereby rotation of the key lock effects linear movement of the shield between its operative and inoperative positions. The key lock 1272 is substantially the same as the key lock 872 of the eighth embodiment, comprising a lock cylinder 1281 sized for positioning within a lock housing 1274 in closely spaced relationship with the housing and capable of rotation within the housing about a rotation axis of the lock cylinder. As shown in FIG. 45, an outer end 1220 of the lock cylinder 1281 is flanged for seating against a recessed shoulder 1222 of the lock housing 1274 to axially position the lock cylinder in the housing. The lock housing 1274 also has a flanged outer end 1224 for seating against the side of the interior door panel 107 external of the pocket 1216. A tubular sleeve 1282 in the door panel 107 is sized for receiving the lock housing 1274 in frictional engagement therewith to inhibit rotation of the lock housing relative to the door panel 107. The key lock 1272 further includes a generally discus plate member 1293 secured to an inner end 1226 of the lock cylinder 1281 by a suitable fastener 1295 inward of the lock housing 1274 for conjoint rotation with the lock cylinder relative to the lock housing. The plate member 1293 includes a cover plate 1296 sized radially larger than the lock housing 1274 and tubular sleeve 1282 so that, upon being fastened to lock cylinder, the cover plate abuts against the housing and sleeve to axially secure the lock cylinder 1281, lock housing and tubular sleeve in the door panel 107.

In the illustrated embodiment, the plate member 1293 also includes a gear plate 1297 having four gear teeth 1283, broadly defining a pinion, extending generally radially outward therefrom for conjoint rotation with the key lock 1272. The number of gear teeth 1283 may vary, however, and may even be limited to a single gear tooth, depending on the desired longitudinal travel of the shield 1275. It is also contemplated that the gear plate 1297 may be omitted, with the gear teeth 1283 extending radially outward from the cover plate 1296, or from the inner end 1226 of the lock cylinder 1281, without departing from the scope of this invention, as long as the gear teeth are conjointly rotatable with the lock cylinder. Corresponding gear teeth 1285 are attached to the shield 1275 and extend generally laterally outward from a lower portion of the shield in the door panel 107 to define a rack. The gear teeth 1285 of the shield 1275 are spaced longitudinally with respect to each other for interengagement with the gear teeth 1283 of the key lock 1272. In the illustrated embodiment, the gear teeth 1285 are centrally positioned on the side of the shield 1275 to extend radially outward from the shield. Alternatively, the gear teeth 1285 may extend laterally outward from the shield 1275 in a manner other than radially, such as generally tangentially to the shield. The term laterally as used herein in reference to the gear teeth 1285 is intended to include not only a perpendicular extension of the gear teeth relative to the shield 1275 but also any outward extension relative to the shield having a lateral component, such as where the gear teeth are angled relative to the shield to extend upward and outward or downward and outward from the shield.

The key lock 1272 is thus operatively connected to the shield 1275 by the rack and pinion connection wherein the gear teeth 1283 of the key lock 1272 interengage the gear teeth 1285 of the shield 1275. To change the locking system from the normal lock mode to the guard lock mode, the key 790 (FIG. 22) is inserted into the lock cylinder 1281 as in prior embodiments to disengage the key lock 1272 from the lock housing 1274 to permit rotation of the key lock relative to the housing to the guard lock mode of the locking system. As the key lock 1272 is rotated, the gear teeth 1283 of the key lock rotate about the rotation axis of the key lock to sequentially interengage the corresponding gear teeth 1285 attached to the shield 1275 for lifting or otherwise pushing upward on the shield, thereby effecting linear movement of the shield to its operative position exterior of the door panel opening 1217. The lock button 1213 is then manually pushed downward to its locked position within the shield 1275 so that the lock button is fully recessed within the shield and is inaccessible for manual movement back to its unlocked position.

As in the previously described embodiments incorporating a key lock, internal channels (not shown, but similar to internal channels 887 of FIG. 27) in the lock housing 1274 respectively corresponding to the normal and guard lock modes receive wafers (not shown) of the lock cylinder 1281 of the key lock 1272 to secure the key lock in the normal and guard lock modes. In this twelfth embodiment, the longitudinal travel of the shield 1275 between its inoperative and operative positions is a function of the angular spacing between the internal channels of the lock housing 1274, e.g., the angle through which the key lock 1272 is rotated in switching from the normal lock mode to the guard lock mode of the locking system. The channels of the illustrated embodiment are angularly spaced to permit rotation of the key lock 1272 through about a 90° rotation. The longitudinal position of the actuator shield 1275 relative to the door panel 107 and lock button 1213, in both the operative and inoperative positions of the shield, depends on the initial positioning of the key lock gear teeth 1283 relative to the gear teeth 1285 of the actuator shield. For example, to achieve the uppermost longitudinal position of the shield 1275 in its operative position, the first gear tooth of the key lock (e.g., gear tooth 1283a in FIG. 43) must be positioned for interengagement with the uppermost gear tooth (e.g., gear tooth 1285a) of the actuator shield when the key lock 1272 is in its normal lock mode and the shield is in its inoperative position. This permits substantially all of the key lock gear teeth 1283 to interengage the shield gear teeth 1285 upon rotation of the key lock 1272 to the guard lock mode of the locking system for pushing the shield 1275 upward relative to the door panel 107.

As such, the key lock housing 1274 of the illustrated embodiment is positioned in the tubular sleeve 1282 so that when the wafers of the key lock cylinder 1281 seat in the internal channel of the housing corresponding to the normal lock mode, the first gear tooth 1283a of the key lock 1272 interengages the uppermost gear tooth 1285a of the shield 1275. To adjust the position of the key lock housing 1274 upon installation in the tubular sleeve 1282, an installation tool 990 (FIG. 30) is provided for rotating the lock housing relative to the tubular sleeve against the frictional engagement between the sleeve and the housing. The tool 990 is a wrench-type tool comprising a lever arm 991 and three pins 992 protruding laterally outward from an end of the lever arm in spaced relationship with each other. Corresponding openings 1298 are formed in the flanged outer end 1224 of the lock housing 1274 in spaced relationship with each other for receiving the pins 992 of the installation tool 990 whereby rotation of the tool effects rotation of the lock housing relative to the tubular sleeve 1282 to permit proper rotational positioning of the internal channels of the lock housing.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A child-safety door locking system for use on an automobile door, said locking system comprising:
a latch;
a handle operatively connected to the latch for latching and unlatching the door;
a locking mechanism operable to lock and unlock the latch, the door handle being incapable of operating to unlatch the door when the locking mechanism locks the latch, the child-safety door locking system being capable of being selectively switched between a normal lock mode in which the door can be manually locked and unlocked, and a guard lock mode in which the door cannot be manually unlocked;
an interior door panel having an inner surface and an outer surface, the outer surface of the door panel having a pocket formed therein;
a manual lock actuator operatively connected to the locking mechanism of the door and disposed at least partially outside the outer surface of the door panel generally within the pocket formed therein, the manual lock actuator being manually movable in the normal lock mode relative to the interior door panel from a location outside the outer surface of the door panel generally within the pocket between a locked position in which the latch on the door is locked and an unlocked position in which the latch on the door is unlocked;
a shield movable relative to the interior door panel and the manual lock actuator between a retracted inoperative position corresponding to the normal lock mode and an extended operative position corresponding to the guard lock mode, in the inoperative position the shield being withdrawn from the manual lock actuator whereby in the locked position the manual lock actuator may be manually grasped and moved to its unlocked position, and in the operative position the shield occupying a position relative to the door panel and manual lock actuator on the outside surface of the door panel generally within the pocket formed therein so that the manual lock actuator is shielded in its locked position to block access to the manual lock actuator for manual movement to its unlocked position, the lock actuator being moveable to its unlocked position when the shield is in its operative position corresponding to the guard lock mode of the locking system; and
a key lock adapted to receive a key therein to permit movement of the key lock between a first position corresponding to the normal lock mode and a second position corresponding to the guard lock mode;
the key lock being operatively connected to the shield in a rack and pinion connection such that turning of the key in the lock effects linear movement of the shield relative to the interior door panel and the manual lock actuator between the normal lock mode and the guard lock mode of the locking system.

2. A child-safety door locking system as set forth in claim 1 wherein the key lock has at least one gear tooth extending generally radially outward therefrom to define a pinion, the shield having at least one corresponding gear tooth defining a rack extending generally laterally outward therefrom for interengagement by at least one gear tooth of the key lock whereby rotation of the key lock effects interengagment of the shield gear tooth by the key lock gear tooth to move the shield translationally relative to the manual lock actuator.

3. A child-safety door locking system as set forth in claim 2 wherein the manual lock actuator comprises a lock button extending outside the outer surface of the door panel, the shield being generally tubular and received around the lock button in generally coaxial relationship therewith about a longitudinal axis of the lock button, the shield being sized to permit relative longitudinal movement of the shield on the lock button between the inoperative and operative positions.

4. A child-safety door locking system as set forth in claim 3 wherein said at least one gear tooth of the shield extends generally radially outward from the shield relative to the longitudinal axis of the lock button.

5. A child-safety door locking system as set forth in claim 1 wherein said door locking system further comprises an indicator for indicating within the interior of the automobile whether the door locking system is in the normal lock mode or the guard lock mode.

6. A child-safety door locking system as set forth in claim 5 wherein the indicator is constructed for visually displaying within the interior of the automobile whether the door locking system is in the normal lock mode or the guard lock mode.

7. A child-safety door locking system as set forth in claim 1 further comprising a lock housing secured in the interior door panel for receiving the key lock, the key lock being sized for selective rotation in the lock housing relative to the interior door panel, the lock housing having a pair of internal channels respectively associated with the normal lock mode and the guard lock mode for receiving the key lock to releasably secure the key lock in the normal lock mode and guard lock mode, the longitudinal position of the shield relative to the interior door panel and manual lock actuator in the guard lock mode of the locking system being at least in part a function of the position of the internal channels of the housing relative to the shield, the lock housing being rotatable in the interior door panel for adjusting the position of the internal channels of the lock housing to adjust the position of the shield relative to the lock actuator and the door panel in the guard lock mode of the locking system.

8. A child-safety door locking system as set forth in claim 7 wherein the lock housing is adapted for engagement by an installation tool for rotating the lock housing relative to the interior door panel to adjust the position of the internal channels of the lock housing.
